(19) United States
(12) Patent Application Publication
(10) Pub. No.: US 2018/0275329 A1
(43) Pub. Date: Sep. 27, 2018

(54) OPTICAL FILM AND METHOD FOR PRODUCING SAME

(71) Applicant: ZEON CORPORATION, Chiyoda-ku, Tokyo (JP)

(72) Inventors: Akira IKEDA, Tokyo (JP); Masakazu SAITO, Tokyo (JP)

(73) Assignee: ZEON CORPORATION, Chiyoda-ku, Tokyo (JP)

(21) Appl. No.: 15/762,215

(22) PCT Filed: Sep. 14, 2016
(86) PCT No.: PCT/JP2016/077183

§ 371 Date: Mar. 22, 2018

(30) Foreign Application Priority Data
Sep. 30, 2015 (JP) 2015-193645

(51) Int. Cl. G02B 5/30; B29D 11/00; C09K 19/34

(52) U.S. Cl. CPC G02B 5/3016; B29D 11/0073; B29K 2995/0041; C09K 19/3497; B29D 11/00865

(57) ABSTRACT

An optical film including a layer of a cured product obtained by curing a liquid crystal composition containing a polymerizable liquid crystal compound and a fluorine atom-containing surfactant, wherein the layer has a first surface, and a second surface opposite to the first surface, a surface fluorine atom amount measured by an X-ray photoelectron spectroscopy on the first surface is less than 25% by mole, and a ratio by mole of the surface fluorine atom amount measured by the X-ray photoelectron spectroscopy on the second surface relative to the surface fluorine atom amount measured by the X-ray photoelectron spectroscopy on the first surface is 0.5 or less.

### FIELD

The present invention relates to an optical film and a method for producing the same.

### BACKGROUND

When an optical film such as a phase difference film is produced by using a liquid crystal compound, the desired optical film may be obtained by applying a liquid crystal composition containing the liquid crystal compound onto an appropriate substrate such as a resin film to form a layer, effecting orientation of the liquid crystal compound in the layer of the liquid crystal composition, and then curing the layer in a state of maintaining the orientation of the liquid crystal compound. The liquid crystal composition used in the method described above may contain a solvent and an additive in combination with the liquid crystal compound (see Patent Literatures 1 to 3).

### CITATION LIST

### Patent Literature

Patent Literature 1: Japanese Patent Application Laid-Open No. 2007-177241 A

Patent Literature 2: Japanese Patent Application Laid-Open No. 2009-232564 A

Patent Literature 3: Japanese Patent Application Laid-Open No. 2013-076851 A

### SUMMARY

### Technical Problem

In general, an optical film is required to have uniform thickness and retardation in the plane. In order to achieve such uniform thickness and retardation, it is required to perform uniform application upon applying a liquid crystal composition onto a substrate. In order to perform such uniform application of the liquid crystal composition, a liquid crystal composition containing a surfactant may be used in some cases. As the surfactant, a fluorine atom-containing surfactant is often used.

However, when the fluorine atom-containing surfactant is used, unevenness may be observed on the optical film under irradiation with an HID lamp (high-intensity discharge lamp) with high intensity. The unevenness may occur not only on an optical film having no uniform thickness and retardation but also on the optical film having uniform thickness and retardation. In a usual using conditions, the unevenness does not impair optical characteristics of the optical film. However, in an actual commercial transaction, a product value of the optical film may be evaluated to be poor due to the unevenness.

The present invention has been made in view of the aforementioned problems. An object of the present invention is to provide an optical film including a layer of a cured product obtained by curing a liquid crystal composition containing a fluorine atom-containing surfactant, the optical film being capable of suppressing unevenness under irradiation with an HID lamp; and a method for producing the optical film.

### Solution to Problem

The present inventors have intensively studied to solve the aforementioned problems. As a result, the inventors have found that when, in a layer of a cured product obtained by curing a liquid crystal composition containing a fluorine atom-containing surfactant, the surface fluorine atom amount of the layer is adjusted, unevenness observed under irradiation of the layer with an HID lamp can be suppressed. Accordingly, the present invention has been completed.

That is, the present invention is as follows:

(1) An optical film comprising a layer of a cured product obtained by curing a liquid crystal composition containing a polymerizable liquid crystal compound and a fluorine atom-containing surfactant, wherein

the layer has a first surface, and a second surface opposite to the first surface,

a surface fluorine atom amount measured by an X-ray photoelectron spectroscopy on the first surface is less than 25% by mole, and

a ratio by mole of the surface fluorine atom amount measured by the X-ray photoelectron spectroscopy on the second surface relative to the surface fluorine atom amount measured by the X-ray photoelectron spectroscopy on the first surface is 0.5 or less.

(2) The optical film according to (1), wherein

the optical film includes a substrate,

the first surface is a surface of the layer opposite to the substrate, and

the second surface is a surface of the layer on the substrate side.

(3) The optical film according to (1) or (2), wherein a ratio of fluorine atom in a molecule of the surfactant is 30% by weight or less.

(4) The optical film according to any one of (1) to (3), wherein the polymerizable liquid crystal compound is capable of expressing birefringence with inverse wavelength dispersion.

(5) The optical film according to any one of (1) to (4), wherein the polymerizable liquid crystal compound contains a main chain mesogen and a side chain mesogen bonded to the main chain mesogen in a molecule of the polymerizable liquid crystal compound.

(6) The optical film according to any one of (1) to (5), wherein the polymerizable liquid crystal compound is represented by the following Formula (I):

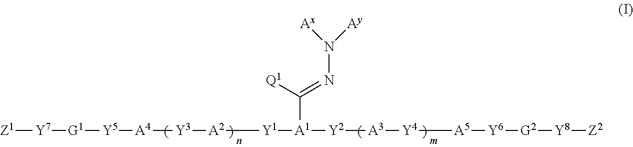

### (in the Formula (I),

Y¹ to Y⁸ are each independently a chemical single bond, —O—, —S—, —O—C(═O)—, —C(═O)—O—, —O—C(═O)—O—, —NR¹—C(═O)—, —C(═O)—NR¹—, —O—C(═O)—NR¹—, —NR¹—C(═O)—O—, —NR¹—C(═O)—NR¹—, —O—NR¹—, or —NR¹—O—, wherein R¹ is a hydrogen atom or an alkyl group of 1 to 6 carbon atoms;

G¹ and G² are each independently a divalent aliphatic group of 1 to 20 carbon atoms optionally having a substituent; the aliphatic groups may have one or more per one aliphatic group of —O—, —S—, —O—C(═O)—, —C(═O)—O—, —O—C(═O)—O—, —NR²—C(═O)—, —C(═O)—NR²—, —NR²—, or —C(═O)— inserted therein; provided that a case where two or more —O— or —S— groups are adjacently inserted are excluded, wherein R² is a hydrogen atom or an alkyl group of 1 to 6 carbon atoms;

Z¹ and Z² are each independently an alkenyl group of 2 to 10 carbon atoms optionally being substituted by a halogen atom;

A^{x} is an organic group of 2 to 30 carbon atoms having at least one aromatic ring selected from the group consisting of an aromatic hydrocarbon ring and an aromatic heterocyclic ring;

A^{y} is a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, —C(═O)—R³, —SO₂—R⁴, —C(═S)NH—R⁹, or an organic group of 2 to 30 carbon atoms having at least one aromatic ring selected from the group consisting of an aromatic hydrocarbon ring and an aromatic heterocyclic ring, wherein R³ is an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic hydrocarbon ring group of 5 to 12 carbon atoms; R⁴ is an alkyl group of 1 to 20 carbon atoms, an alkenyl group of 2 to 20 carbon atoms, a phenyl group, or a 4-methylphenyl group; R⁹ is an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic group of 5 to 20 carbon atoms optionally having a substituent; the aromatic ring that A^{x} and A^{y} have may have a substituent; and A^{x} and A^{y} may form a ring together;

A¹ is a trivalent aromatic group optionally having a substituent;

A² and A³ are each independently a divalent alicyclic hydrocarbon group of 3 to 30 carbon atoms optionally having a substituent;

A⁴ and A⁵ are each independently a divalent aromatic group of 6 to 30 carbon atoms optionally having a substituent;

Q¹ is a hydrogen atom or an alkyl group of 1 to 6 carbon atoms optionally having a substituent; and m and n are each independently 0 or 1).

(7) A method for producing an optical film comprising steps of:

applying a liquid crystal composition containing a polymerizable liquid crystal compound and a fluorine atom-containing surfactant onto a substrate; and

polymerizing the polymerizable liquid crystal compound contained in the liquid crystal composition applied onto the substrate, to obtain a layer of a cured product of the liquid crystal composition, wherein

a surface fluorine atom amount measured by an X-ray photoelectron spectroscopy on the surface opposite to the substrate of the layer is less than 25% by mole, and

a ratio by mole of the surface fluorine atom amount measured by the X-ray photoelectron spectroscopy on a surface on the substrate side of the layer relative to the surface fluorine atom amount measured by the X-ray photoelectron spectroscopy on the surface opposite to the substrate of the layer is 0.5 or less.

### Advantageous Effects of Invention

The present invention can provide an optical film including a layer of a cured product obtained by curing a liquid crystal composition containing a fluorine atom-containing surfactant, the optical film being capable of suppressing unevenness under irradiation with an HID lamp; and a method for producing the same.

### BRIEF DESCRIPTION OF DRAWINGS

FIG. 1 is a cross-sectional view schematically illustrating a cross section of an optical film according to one embodiment of the present invention.

FIG. 2 is a graph in which the surface fluorine atom amount of the liquid crystal cured layer measured in the optical film produced in Examples 1 to 3 are plotted against the amount of the used surfactant.

FIG. 3 is a graph in which the surface fluorine atom amount of the liquid crystal cured layer measured in the optical film produced in Examples 4 to 6 are plotted against the amount of the used surfactant.

FIG. 4 is a graph in which the surface fluorine atom amount of the liquid crystal cured layer measured in the optical film produced in Examples 7 to 9 are plotted against the amount of the used surfactant.

FIG. 5 is a graph in which the surface fluorine atom amount of the liquid crystal cured layer measured in the optical film produced in Examples 10 and 11 are plotted against the amount of the used surfactant.

FIG. 6 is a graph in which the surface fluorine atom amount of the liquid crystal cured layer measured in the optical film produced in Examples 12 to 14 are plotted against the amount of the used surfactant.

FIG. 7 is a graph in which the surface fluorine atom amount of the liquid crystal cured layer measured in the optical film produced in Comparative Examples 1 and 2 are plotted against the amount of the used surfactant.

FIG. 8 is a graph in which the surface fluorine atom amount of the liquid crystal cured layer measured in the optical film produced in Comparative Examples 3 and 4 are plotted against the amount of the used surfactant.

FIG. 9 is a graph in which the surface fluorine atom amount of the liquid crystal cured layer measured in the optical film produced in Comparative Examples 5 and 6 are plotted against the amount of the used surfactant.

FIG. 10 is a graph in which the surface fluorine atom amount of the liquid crystal cured layer measured in the optical film produced in Comparative Examples 7 to 11 are plotted against the amount of the used surfactant.

FIG. 11 is a photograph illustrating a state of the optical film under irradiation with the HID lamp.

FIG. 12 is a photograph illustrating a state of the optical film under irradiation with a white fluorescent lamp.

FIG. 13 is a photograph illustrating a state where the optical film is placed between two linear polarizers layered so as to be in parallel Nicols.

### DESCRIPTION OF EMBODIMENTS

Hereinafter, the present invention will be described in detail with reference to examples and embodiments. However, the present invention is not limited to the following examples and embodiments and may be freely modified for implementation without departing from the scope of claims of the present invention and the scope of their equivalents.

Unless otherwise specified, the term “polarizing plate” and the term “wave plate” in the following description encompass a film and a sheet that have flexibility, such as a resin film.

In the following description, a resin having a positive intrinsic birefringence value means a resin whose refractive index in a stretching direction is larger than the refractive index in a direction perpendicular to the stretching direction. A resin having a negative intrinsic birefringence value means a resin whose refractive index in a stretching direction is smaller than the refractive index in a direction perpendicular to the stretching direction. The intrinsic birefringence value may be calculated from a dielectric constant distribution.

Unless otherwise specified, a retardation of a layer in the following description represents an in-plane retardation Re. Unless otherwise specified, the in-plane retardation Re is a value represented by Re=(nx−ny)×d. Herein, nx represents a refractive index in a direction that gives the largest refractive index among directions perpendicular to the thickness direction of the layer (in-plane directions), ny represents a refractive index in a direction that is an in-plane direction of the layer that is perpendicular to the direction of nx, and d represents a thickness of the layer. Unless otherwise specified, a measurement wavelength of a retardation is 550 nm.

Unless otherwise specified, the direction of the slow axis of a certain layer in the following description means the direction of the slow axis among the in-plane directions.

Unless otherwise specified, directions of elements that are “parallel” and “perpendicular” in the following description may allow an error within a range that does not impair the effects of the present invention, for example, within a range of ±5°, preferably ±3°, and more preferably ±1°.

[1. Summary of Optical Film]

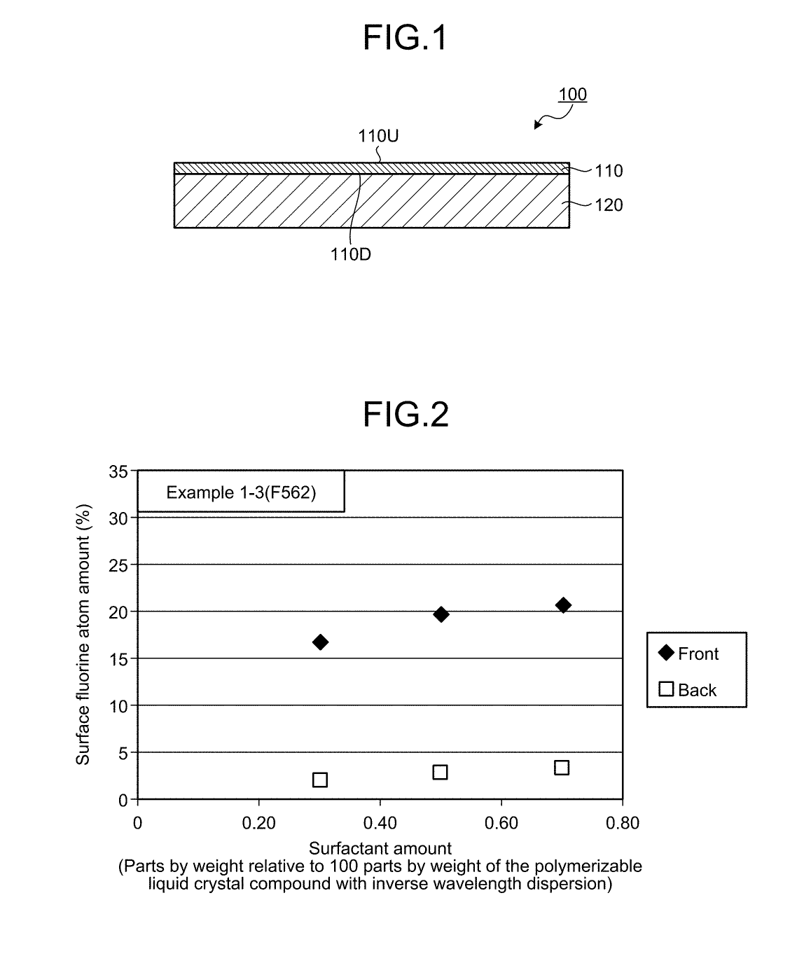

FIG. 1 is a cross-sectional view schematically illustrating a cross section of an optical film according to one embodiment of the present invention. As shown in FIG. 1, an optical film 100 according to the embodiment of the present invention includes a layer 110 of a cured product obtained by curing a liquid crystal composition. Hereinafter, the layer 110 of the cured product may be appropriately referred to as “liquid crystal cured layer”. The liquid crystal composition mentioned above contains a polymerizable liquid crystal compound and a fluorine atom-containing surfactant. Since the surfactant contains fluorine atoms, the liquid crystal cured layer 110 contains fluorine atoms.

The liquid crystal cured layer 110 mentioned above has a first surface 110U and a second surface 110D opposite to the first surface 110U. The amount of fluorine atoms on the first surface 110U and the second surface 110D may be measured by an X-ray photoelectron spectroscopy (XPS). In the following description, the amount of fluorine atoms measured by the X-ray photoelectron spectroscopy may be appropriately referred to as “surface fluorine atom amount”.

The optical film 100 according to the embodiment of the present invention satisfies the following requirements (a) and (b).

(a): The surface fluorine atom amount measured by the X-ray photoelectron spectroscopy on the first surface 110U falls within a specific range.

(b): The ratio by mole of the surface fluorine atom amount measured by the X-ray photoelectron spectroscopy on the second surface 110D relative to that on the first surface 110U falls within a specific range.

When a combination of the requirements (a) and (b) is satisfied, the optical film 100 can suppress unevenness under irradiation with an HID lamp. In the following description, “the ratio by mole of the surface fluorine atom amount measured by the X-ray photoelectron spectroscopy on the second surface relative to that on the first surface” may be appropriately referred to as “surface fluorine amount ratio”.

The optical film 100 may be provided with a substrate 120. The substrate 120 is usually a layer that has been used to form the liquid crystal cured layer 110. When the optical film 100 is provided with the substrate 120, the surface of the liquid crystal cured layer 110 opposite to the substrate 120 is the first surface 110U, and the surface of the liquid crystal cured layer on the substrate 120 side is the second surface 110D. In the following description, the first surface 110U is appropriately referred to as “front surface” and the second surface 110D is appropriately referred to as “back surface”.

[2. Liquid Crystal Cured Layer]

### [2.1. Description of Surface Fluorine Atom Amount]

The liquid crystal cured layer is a layer of a cured product obtained by curing the liquid crystal composition containing the polymerizable liquid crystal compound and the surfactant. Since the aforementioned surfactant contains fluorine atoms, the fluorine atoms are usually detected by analysis of the surfaces (the front and back surfaces) of the liquid crystal cured layer by the X-ray photoelectron spectroscopy.

The surface fluorine atom amount measured by the X-ray photoelectron spectroscopy on the front surface of the liquid crystal cured layer is usually less than 25% by mole, and preferably 10% by mole or less (see the requirement (a)). When the surface fluorine atom amount of the front surface of the liquid crystal cured layer is decreased as described above, unevenness under irradiation with an HID lamp can be suppressed. Since the surface fluorine atom amount of the front surface is small, transport of fluorine from the liquid crystal cured layer to a production facility such as a conveying roller can be usually suppressed. Therefore, contamination of a device can be suppressed. The lower limit value of the surface fluorine atom amount of the front surface of the liquid crystal cured layer is not particularly limited, but is preferably 1% by mole or more. By having the surface fluorine atom amount on the front surface of the liquid crystal cured layer being equal to or more than the aforementioned lower limit value, the application properties of the liquid crystal composition onto the substrate upon production of a liquid crystal cured layer having a low thickness are improved.

In general, in a liquid crystal composition containing a surfactant, the surfactant tends to gather in the vicinity of an air interface. Therefore, the fluorine atoms contained in the surfactant gather in the vicinity of air interface of the liquid crystal composition. In the layer of the cured product of the liquid crystal composition, the amount of fluorine atoms on a surface corresponding to the air interface (corresponding to the front surface of the liquid crystal cured layer) tends to be increased. When the amount of fluorine atoms is thus large, chemical species such as fluorine atom-containing functional groups and fluorine atom-containing molecules are aggregated to form a lump. As a result, the surface state of the layer of the cured product is made coarse. The degree of making the surface state coarse by the lump is usually low, and thus optical characteristics such as retardation of the layer of the cured product are not impaired. However, a slightly uniform surface state is visually recognized as a difference in texture or color under irradiation with high intensity light from an HID lamp. Therefore, unevenness has been observed in prior art. On the other hand, in the liquid crystal cured layer according to this embodiment, the surface fluorine atom amount of the front surface corresponding to the air interface is small, and thus the formation of a lump due to aggregation of fluorine atom-containing chemical species is suppressed. Therefore, the surface state is not made coarse due to the lump. It is estimated that unevenness can thereby be suppressed under irradiation with an HID lamp. However, the technical scope of the present invention is not restricted by the aforementioned estimation.

Examples of a method for confining the surface fluorine atom amount of the front surface of the liquid crystal cured layer within the specific range may include a method for appropriately adjusting a combination of the polymerizable liquid crystal compound and the surfactant, and a method for selecting a surfactant containing an appropriate fluorine atom content.

Further, the surface fluorine amount ratio of the liquid crystal cured layer (that is, the ratio by mole of the surface fluorine atom amount measured by the X-ray photoelectron spectroscopy on the back surface relative to the surface fluorine atom amount measured by the X-ray photoelectron spectroscopy on the front surface (back surface/front surface)) is equal to or less than a specific value. Specifically, the aforementioned surface fluorine amount ratio is usually 0.5 or less. When the surface fluorine amount ratio is thus made small, unevenness under irradiation with an HID lamp can be suppressed. The lower limit value of the surface fluorine amount ratio is not particularly limited, but is preferably 0.01 or more. When the surface fluorine amount ratio is equal to or more than the lower limit value, desired liquid crystal orientation quality of the liquid crystal cured layer can be improved.

When the liquid crystal composition containing the liquid crystal compound and the surfactant is applied onto the substrate, part of the surfactant gathers in the vicinity of the air interface as described above. Herein, the surfactant that has not gathered in the vicinity of the air interface is considered. When the affinity between the liquid crystal compound and the surfactant is low, the surfactant that has not gathered in the air interface gathers in the vicinity of an interface between the liquid crystal composition and the substrate. Therefore, the amount of fluorine atoms on the surface corresponding to the interface between the liquid crystal composition and the substrate (corresponding to the back surface of the liquid crystal cured layer) is increased in the layer of the cured product of the liquid crystal composition. As a result, the surface fluorine amount ratio is increased. In contrast, when the affinity between the liquid crystal compound and the surfactant is high, the surfactant that has not gathered in the air interface does not gather in the vicinity of an interface between the liquid crystal composition and the substrate, and is widely dispersed in the liquid crystal composition. Therefore, the amount of fluorine atoms on the surface corresponding to the interface between the liquid crystal composition and the substrate (corresponding to the back surface of the liquid crystal cured layer) is decreased in the layer of the cured product of the liquid crystal composition. As a result, the surface fluorine amount ratio is decreased. Thus, the decreased surface fluorine amount ratio as in the liquid crystal cured layer according to this embodiment indicates that the affinity between the polymerizable liquid crystal compound and the surfactant is high. When the affinity between the polymerizable liquid crystal compound and the surfactant is high, dispersibility of the surfactant can be enhanced, and the composition of the liquid crystal composition applied onto the substrate can be made uniform at a high level. Therefore, the surface state of the liquid crystal cured layer can be improved. It is estimated that unevenness can thus be suppressed under irradiation with an HID lamp. However, the technical scope of the present invention is not restricted by the aforementioned estimation.

Examples of a method for confining the surface fluorine amount ratio of the liquid crystal cured layer within the specific range may include a method for appropriately adjusting a combination of the polymerizable liquid crystal compound and the surfactant.

### [2.2. Description of Liquid Crystal Composition]

The liquid crystal composition contains the polymerizable liquid crystal compound and the fluorine atom-containing surfactant. The liquid crystal composition may further contain an optional component such as a solvent and a polymerization initiator. The form of the liquid crystal composition at normal temperature is not limited to a powder or liquid form. However, the liquid crystal composition usually has a fluid form at a temperature region at which an orientation treatment is performed (usually 50° C. to 150° C.), and preferably has a fluid form at a temperature region at which applying is performed.

(2.2.1. Polymerizable Liquid Crystal Compound)

The polymerizable liquid crystal compound is a liquid crystal compound having polymerizability. The polymerizable liquid crystal compound is a compound having a nature of liquid crystal. Therefore, when the polymerizable liquid crystal compound is oriented, the compound can exhibit a liquid crystal phase. Further, as the polymerizable liquid crystal compound is a compound having polymerizability, the compound can be polymerized while being in a state of exhibiting the liquid crystal phase as described above, to be a polymer in which the orientation of molecules in the liquid crystal phase is maintained. When the polymerizable liquid crystal compound is thus polymerized, the liquid crystal composition can be cured to obtain a cured product.

As the polymerizable liquid crystal compound, a polymerizable liquid crystal compound capable of expressing birefringence with inverse wavelength dispersion is preferably used. In the following description, the polymerizable liquid crystal compound capable of expressing birefringence with inverse wavelength dispersion may be referred to as “polymerizable liquid crystal compound with inverse wavelength dispersion” as appropriate. When the polymerizable liquid crystal compound with inverse wavelength dispersion is used, a desired effect of the present invention can be more favorably expressed. Herein, the polymerizable liquid crystal compound capable of expressing birefringence with inverse wavelength dispersion means a polymerizable liquid crystal compound the polymer of which that is obtained the aforementioned manner expresses birefringence with inverse wavelength dispersion.

The birefringence with inverse wavelength dispersion means birefringence in which a birefringence Δn(450) at a wavelength of 450 nm and a birefringence Δn(650) at a wavelength of 650 nm satisfy the following expression (D1). A polymerizable liquid crystal compound capable of expressing such birefringence with inverse wavelength dispersion can usually express larger birefringence at a longer measurement wavelength. Therefore, the birefringence of the polymer obtained by polymerization of the polymerizable liquid crystal compound with inverse wavelength dispersion as described above usually satisfies the following expression (D2). In the following expression (D2), Δn(550) represents a birefringence at a measurement wavelength of 550 nm.

Δn(450)<Δn(650) (D1)

Δn(450)<Δn(550)<Δn(650) (D2)

As the polymerizable liquid crystal compound with inverse wavelength dispersion, a compound having a main chain mesogen and a side chain mesogen bonded to the main chain mesogen in a molecule of the polymerizable liquid crystal compound with inverse wavelength dispersion may be used. While the polymerizable liquid crystal compound with inverse wavelength dispersion having the main chain mesogen and the side chain mesogen is in a state of being oriented, the side chain mesogen may be oriented in a direction different from that of the main chain mesogen. Therefore, the main chain mesogen and the side chain mesogen may be oriented in different directions in the polymer obtained by polymerization of the polymerizable liquid crystal compound with inverse wavelength dispersion while such orientation is maintained. In this case, the birefringence is expressed as a difference between the refractive index of the main chain mesogen and the refractive index of the side chain mesogen. As a result, the polymerizable liquid crystal compound with inverse wavelength dispersion and the polymer thereof can express birefringence with inverse wavelength dispersion.

The steric structure of the compound having the main chain mesogen and the side chain mesogen described above is a specific structure that is different from that of a general liquid crystal compound with forward wavelength dispersion. Herein, the “liquid crystal compound with forward wavelength dispersion” means a polymerizable liquid crystal compound capable of expressing birefringence with forward wavelength dispersion. The birefringence with forward wavelength dispersion represents a birefringence of which the absolute value is smaller as the measurement wavelength is longer. When the polymerizable liquid crystal compound has the specific steric structure as described above, the desired effect of the present invention can be more favorably expressed.

Specific examples of preferable polymerizable liquid crystal compounds with inverse wavelength dispersion may include a compound represented by the following formula (I). In the following description, the compound represented by the formula (I) may be appropriately referred to as “compound (I)”.

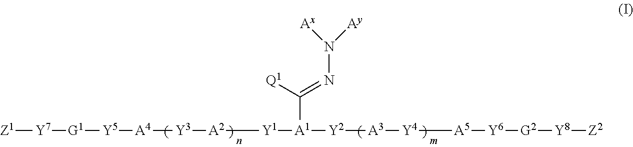

As shown in the following formula, the compound (I) usually includes two mesogen skeletons including a main chain mesogen 1a composed of a group —Y⁵-A⁴-(Y³-A²)ₙ-Y¹-A¹-Y²-(A³-Y⁴)ₘ-A⁵-Y⁶— and a side chain mesogen 1b composed of a group >A¹-C(Q¹)=N—N(A^{x})A^{y}. The main chain mesogen 1a and the side chain mesogen 1b cross each other. The aforementioned main chain mesogen 1a and side chain mesogen 1b may be collectively regarded as one mesogen, but in the present invention, are described as two separate mesogens.

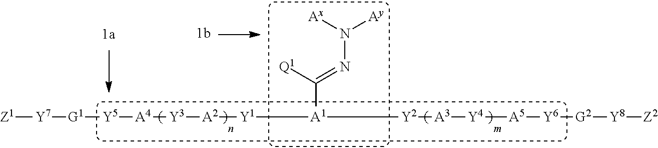

The refractive index of the main chain mesogen 1a in the long-axis direction is denoted by n1, and the refractive index of the side chain mesogen 1b in the long-axis direction is denoted by n2. In this case, the absolute value and wavelength dispersion of the refractive index n1 usually depend on the molecular structure of the main chain mesogen 1a. The absolute value and wavelength dispersion of the refractive index n2 usually depend on the molecular structure of the side chain mesogen 1b. Herein, the polymerizable liquid crystal compound with inverse wavelength dispersion is usually subjected to rotational motion around the long-axis direction of the main chain mesogen 1a as a rotational axis in the liquid crystal phase. Therefore, the refractive indices n1 and n2 herein represent the refractive index of a rotating body.

Due to the molecular structures of the main chain mesogen 1a and the side chain mesogen 1b, the absolute value of the refractive index n1 is larger than the absolute value of the refractive index n2. Further, the refractive indices n1 and n2 usually exhibit forward wavelength dispersion. A refractive index with forward wavelength dispersion herein means a refractive index of which the absolute value becomes smaller as the measurement wavelength is longer. The refractive index n1 of the main chain mesogen 1a exhibits small forward wavelength dispersion. Therefore, the refractive index measured at a long wavelength is not at a level that is extremely smaller than the refractive index measured at a short wavelength. In contrast, the refractive index n2 of the side chain mesogen 1b exhibits large forward wavelength dispersion. Therefore, the refractive index measured at a long wavelength is extremely smaller than the refractive index measured at a short wavelength. Consequently, the difference Δn between the refractive index n1 and the refractive index n2 is small at the short measurement wavelength, and the difference Δn between the refractive index n1 and the refractive index n2 is large at the long measurement wavelength. Accordingly, birefringence with inverse wavelength dispersion can be expressed on the basis of the main chain mesogen 1a and the side chain mesogen 1b.

In the formula (I) mentioned above, Y¹ to Y⁸ are each independently a chemical single bond, —O—, —S—, —O—C(═O)—, —C(═O)—O—, —O—C(═O)—O—, —NR¹—C(═O)—, —C(═O)—NR¹—, —O—C(═O)—NR¹—, —NR¹—C(═O)—O—, —NR¹—C(═O)—NR¹—, —O—NR¹—, or —NR¹—O—.

Herein, R¹ is a hydrogen atom or an alkyl group of 1 to 6 carbon atoms.

Examples of the alkyl group of 1 to 6 carbon atoms of R¹ may include a methyl group, an ethyl group, a n-propyl group, an isopropyl group, a n-butyl group, a sec-butyl group, a t-butyl group, a n-pentyl group, and a n-hexyl group.

It is preferable that R¹ is a hydrogen atom or an alkyl group of 1 to 4 carbon atoms.

In the compound (I), it is preferable that Y¹ to Y⁸ are each independently a chemical single bond, —O—, —O—C(═O)—, —C(═O)—O—, or —O—C(═O)—O—.

In the formula (I) mentioned above, G¹ and G² are each independently a divalent aliphatic group of 1 to 20 carbon atoms optionally having a substituent.

Examples of the divalent aliphatic group of 1 to 20 carbon atoms may include a divalent aliphatic group having a linear structure, such as an alkylene group of 1 to 20 carbon atoms and an alkenylene group of 2 to 20 carbon atoms; and a divalent aliphatic group, such as a cycloalkanediyl group of 3 to 20 carbon atoms, a cycloalkenediyl group of 4 to 20 carbon atoms, and a divalent alicyclic fused ring group of 10 to 30 carbon atoms.

Examples of the substituent in the divalent aliphatic group of G¹ and G² may include a halogen atom, such as a fluorine atom, a chlorine atom, a bromine atom, and an iodine atom; and an alkoxy group of 1 to 6 carbon atoms, such as a methoxy group, an ethoxy group, a n-propoxy group, an isopropoxy group, a n-butoxy group, a sec-butoxy group, a t-butoxy group, a n-pentyloxy group, and a n-hexyloxy group. Among these, a fluorine atom, a methoxy group, and an ethoxy group are preferable.

The aforementioned aliphatic groups may have one or more per one aliphatic group of —O—, —S—, —O—C(═O)—, —C(═O)—O—, —O—C(═O)—O—, —NR²—C(═O)—, —C(═O)—NR²—, —NR²—, or —C(═O)— inserted therein. However, cases where two or more —O— or —S— are adjacently inserted are excluded. Herein, R² is a hydrogen atom or an alkyl group of 1 to 6 carbon atoms. It is preferable that R² is a hydrogen atom or a methyl group.

It is preferable that the group inserted into the aliphatic groups is —O—, —O—C(═O)—, —C(═O)—O—, or —C(═O)—.

Specific examples of the aliphatic groups into which the group is inserted may include —CH₂—CH₂—O—CH₂—CH₂—, —CH₂—CH₂—S—CH₂—CH₂—, —CH₂—CH₂—O—C(═O)—CH₂—CH₂—, —CH₂—CH₂—C(═O)—O—CH₂—CH₂—, —CH₂—CH₂—C(═O)—O—CH₂—, —CH₂—O—C(═O)—O—CH₂—CH₂—, —CH₂—CH₂—NR²—C(═O)—CH₂—CH₂—, —CH₂—CH₂—C(═O)—NR²—CH₂—, —CH₂—NR²—CH₂—CH₂—, and —CH₂—C(═O)—CH₂—.

Among these, from the viewpoint of more favorably expressing the desired effect of the present invention, G¹ and G² are each independently preferably a divalent aliphatic group having a linear structure, such as an alkylene group of 1 to 20 carbon atoms and an alkenylene group of 2 to 20 carbon atoms, more preferably an alkylene group of 1 to 12 carbon atoms, such as a methylene group, an ethylene group, a trimethylene group, a propylene group, a tetramethylene group, a pentamethylene group, a hexamethylene group, an octamethylene group, and a decamethylene group [—(CH₂)₁₀—], and particularly preferably a tetramethylene group [—(CH₂)₄—], a hexamethylene group [—(CH₂)₆—], an octamethylene group [—(CH₂)₈—], or a decamethylene group [—(CH₂)₁₀—].

In the formula (I) mentioned above, Z¹ and Z² are each independently an alkenyl group of 2 to 10 carbon atoms that may be substituted by a halogen atom.

It is preferable that the number of carbon atoms in the alkenyl group is 2 to 6. Examples of the halogen atom that is a substituent in the alkenyl group of Z¹ and Z² may include a fluorine atom, a chlorine atom, and a bromine atom. A chlorine atom is preferable.

Specific examples of the alkenyl group of 2 to 10 carbon atoms of Z¹ and Z² may include CH₂═CH—, CH₂═C(CH₃)—, CH₂═CH—CH₂—, CH₃—CH═CH—, CH₂═CH—CH₂—CH₂—, CH₂═C(CH₃)—CH₂—CH₂—, (CH₃)₂C═CH—CH₂—, (CH₃)₂C—CH—CH₂—CH₂—, CH₂═C(Cl)—, CH₂—C(CH₃) CH₂—, and CH₃—CH═CH—CH₂—.

Among these, from the viewpoint of favorably expressing the desired effect of the present invention, Z¹ and Z² are each independently preferably CH₂═CH—, CH₂═C(CH₃)—, CH₂═C(Cl)—, CH₂═CH—CH₂—, CH₂═C(CH₃)—CH₂—, or CH₂═C(CH₃)—CH₂—CH₂—, more preferably CH₂═CH—, CH₂═C(CH₃)— or CH₂═C(Cl)—, and particularly preferably CH₂═CH—.

In the formula (I) mentioned above, A^{x} is an organic group of 2 to 30 carbon atoms having at least one aromatic ring selected from the group consisting of an aromatic hydrocarbon ring and an aromatic heterocyclic ring. The “aromatic ring” means a cyclic structure having aromaticity in the broad sense based on Huckel rule, that is, a cyclic conjugated structure having (4n+2) π electrons, and a cyclic structure that exhibits aromaticity by involving a lone pair of electrons of a heteroatom, such as sulfur, oxygen, and nitrogen, in a π electron system, typified by thiophene, furan, and benzothiazole.

The organic group of 2 to 30 carbon atoms having at least one aromatic ring selected from the group consisting of an aromatic hydrocarbon ring and an aromatic heterocyclic ring, of A^{x}, may have a plurality of aromatic rings, or have both an aromatic hydrocarbon ring and an aromatic heterocyclic ring.

Examples of the aromatic hydrocarbon ring may include a benzene ring, a naphthalene ring, and an anthracene ring. Examples of the aromatic heterocyclic ring may include a monocyclic aromatic heterocyclic ring, such as a pyrrole ring, a furan ring, a thiophene ring, a pyridine ring, a pyridazine ring, a pyrimidine ring, a pyrazine ring, a pyrazole ring, an imidazole ring, an oxazole ring, and a thiazole ring; and a fused aromatic heterocyclic ring, such as a benzothiazole ring, a benzoxazole ring, a quinoline ring, a phthalazine ring, a benzimidazole ring, a benzopyrazole ring, a benzofuran ring, a benzothiophene ring, a thiazolopyridine ring, an oxazolopyridine ring, a thiazolopyrazine ring, an oxazolopyrazine ring, a thiazolopyridazine ring, an oxazolopyridazine ring, a thiazolopyrimidine ring, and an oxazolopyrimidine ring.

The aromatic ring of A^{x} may have a substituent. Examples of the substituent may include a halogen atom, such as a fluorine atom and a chlorine atom; a cyano group; an alkyl group of 1 to 6 carbon atoms, such as a methyl group, an ethyl group, and a propyl group; an alkenyl group of 2 to 6 carbon atoms, such as a vinyl group and an allyl group; a halogenated alkyl group of 1 to 6 carbon atoms, such as a trifluoromethyl group; a substituted amino group, such as a dimethylamino group; an alkoxy group of 1 to 6 carbon atoms, such as a methoxy group, an ethoxy group, and an isopropoxy group; a nitro group; an aryl group, such as a phenyl group and a naphthyl group; —C(═O)—R⁵; —C(═O)—OR⁵; and —SO₂R⁶. Herein, R⁵ is an alkyl group of 1 to 20 carbon atoms, an alkenyl group of 2 to 20 carbon atoms, or a cycloalkyl group of 3 to 12 carbon atoms. R⁶ is an alkyl group of 1 to 20 carbon atoms, an alkenyl group of 2 to 20 carbon atoms, a phenyl group, or a 4-methylphenyl group, which are the same as those for R⁴ which will be described later.

The aromatic ring of A^{x} may have a plurality of substituents that may be the same or different, and two adjacent substituents may be bonded together to form a ring. The formed ring may be a monocycle or a fused polycycle, and may be an unsaturated ring or a saturated ring.

The “number of carbon atoms” in the organic group of 2 to 30 carbon atoms of A^{x} means the total number of carbon atoms in the entire organic group which excludes carbon atoms in the substituents (the same applies to A^{y} which will be described later).

Examples of the organic group of 2 to 30 carbon atoms having at least one aromatic ring selected from the group consisting of an aromatic hydrocarbon ring and an aromatic heterocyclic ring, of A^{x}, may include an aromatic hydrocarbon ring group; an aromatic heterocyclic group; an alkyl group of 3 to 30 carbon atoms having at least one aromatic ring selected from the group consisting of an aromatic hydrocarbon ring and an aromatic heterocyclic ring; an alkenyl group of 4 to 30 carbon atoms having at least one aromatic ring selected from the group consisting of an aromatic hydrocarbon ring and an aromatic heterocyclic ring; and an alkynyl group of 4 to 30 carbon atoms having at least one aromatic ring selected from the group consisting of an aromatic hydrocarbon ring and an aromatic heterocyclic ring.

Preferable specific examples of A^{x} are as follows. However, A^{x} is not limited to the following examples. In the following formulae, “—” represents an atomic bonding at any position of the ring (the same applies to the following).

(1) An aromatic hydrocarbon ring group

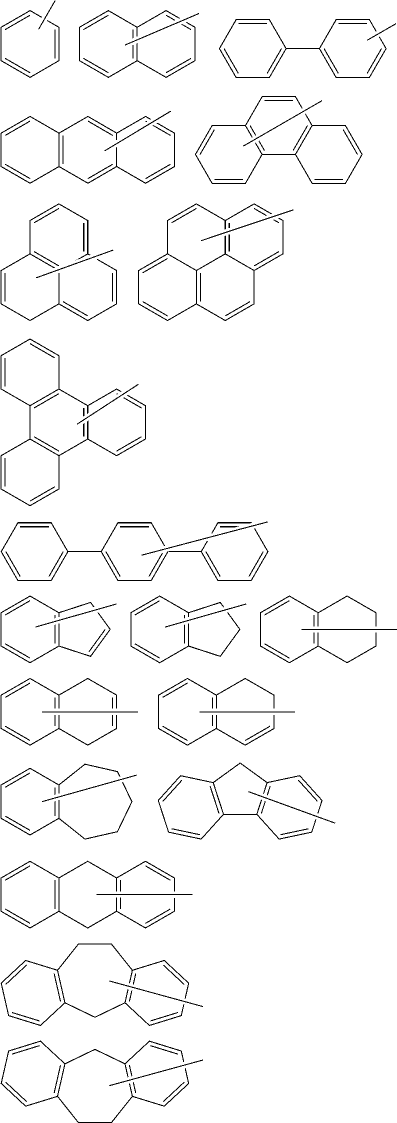

(2) An aromatic heterocyclic group

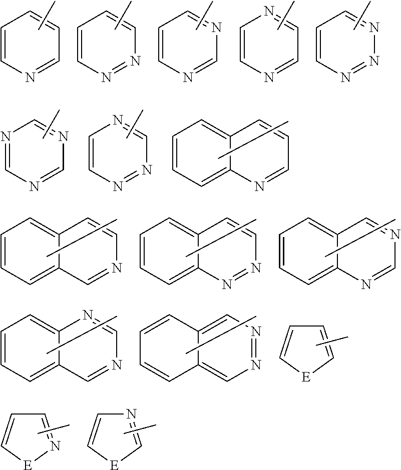

In the aforementioned formulae, E is NR^{6a}, an oxygen atom, or a sulfur atom. Herein, R^{6a} is a hydrogen atom; or an alkyl group of 1 to 6 carbon atoms, such as a methyl group, an ethyl group, and a propyl group.

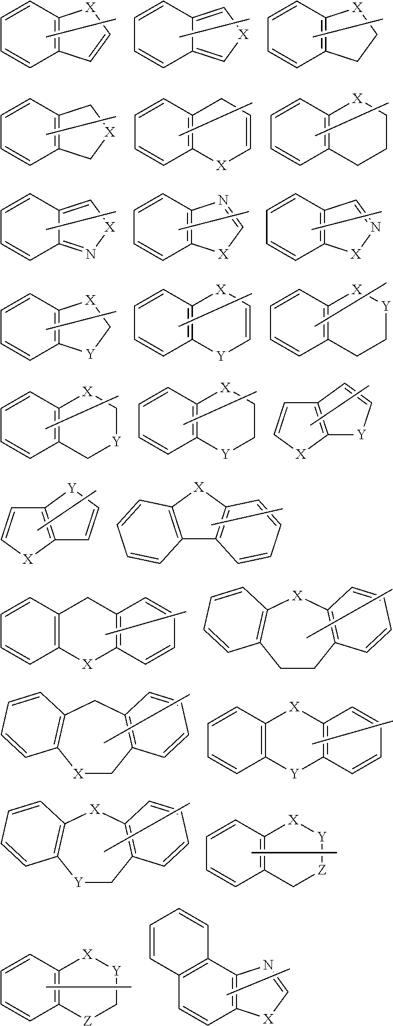

In the aforementioned formulae, X, Y, and Z are each independently NR⁷, an oxygen atom, a sulfur atom, —SO—, or —SO₂— (provided that cases where an oxygen atom, a sulfur atom, —SO—, and —SO₂— are each adjacent are excluded). R⁷ is a hydrogen atom, or an alkyl group of 1 to 6 carbon atoms, such as a methyl group, an ethyl group, and a propyl group, which are the same as those for R^{6a} described above.

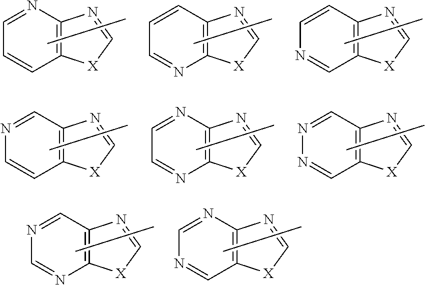

(In the aforementioned formulae, X has the same meanings as described above.)

(3) An alkyl group having at least one aromatic ring selected from the group consisting of an aromatic hydrocarbon ring and an aromatic heterocyclic ring

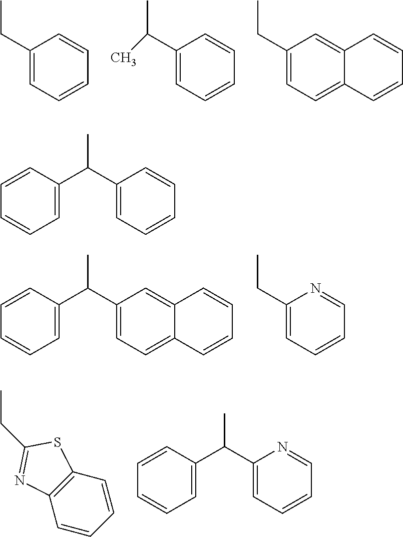

(4) An alkenyl group having at least one aromatic ring selected from the group consisting of an aromatic hydrocarbon ring and an aromatic heterocyclic ring

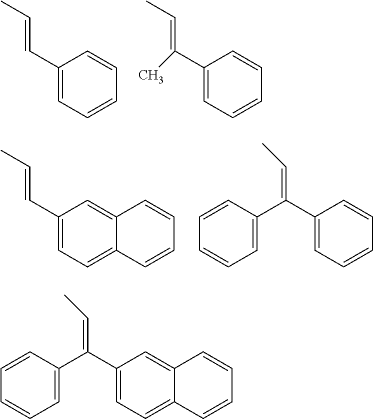

(5) An alkynyl group having at least one aromatic ring selected from the group consisting of an aromatic hydrocarbon ring and an aromatic heterocyclic ring

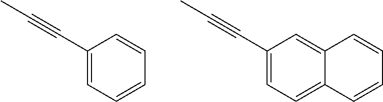

Of A^{x} described above, an aromatic hydrocarbon ring group of 6 to 30 carbon atoms and an aromatic heterocyclic group of 4 to 30 carbon atoms are preferable, and any of the groups shown below are more preferable.

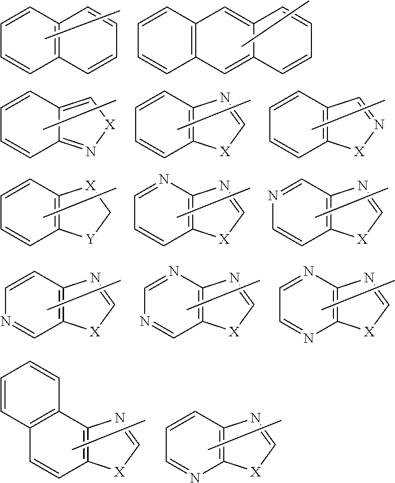

It is further preferable that A^{x} is any of the following groups.

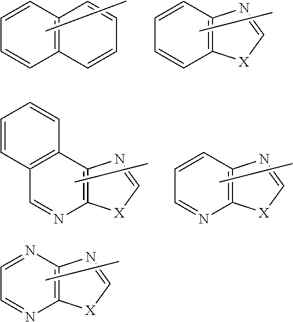

The ring that A^{x} has may have a substituent. Examples of such a substituent may include a halogen atom, such as a fluorine atom and a chlorine atom; a cyano group; an alkyl group of 1 to 6 carbon atoms, such as a methyl group, an ethyl group, and a propyl group; an alkenyl group of 2 to 6 carbon atoms, such as a vinyl group and an allyl group; a halogenated alkyl group of 1 to 6 carbon atoms, such as a trifluoromethyl group; a substituted amino group, such as a dimethylamino group; an alkoxy group of 1 to 6 carbon atoms, such as a methoxy group, an ethoxy group, and an isopropoxy group; a nitro group; an aryl group, such as a phenyl group and a naphthyl group; —C(═O)—R⁸; —C(═O)—OR⁸; and —SO₂R⁶. Herein, R⁸ is an alkyl group of 1 to 6 carbon atoms, such as a methyl group and an ethyl group; or an aryl group of 6 to 14 carbon atoms, such as a phenyl group. In particular, it is preferable that the substituent is a halogen atom, a cyano group, an alkyl group of 1 to 6 carbon atoms, or an alkoxy group of 1 to 6 carbon atoms.

The ring that A^{x} has may have a plurality of substituents that may be the same or different, and two adjacent substituents may be bonded together to form a ring. The formed ring may be a monocycle or a fused polycycle.

The “number of carbon atoms” in the organic group of 2 to 30 carbon atoms of A^{x} means the total number of carbon atoms in the entire organic group which excludes carbon atoms in the substituents (the same applies to A^{y} which will be described later).

In the aforementioned formula (I), A^{y} is a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, —C(═O)—R³, —SO₂—R⁴, —C(═S)NH—R⁹, or an organic group of 2 to 30 carbon atoms having at least one aromatic ring selected from the group consisting of an aromatic hydrocarbon ring and an aromatic heterocyclic ring. Herein, R³ is an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic hydrocarbon ring group of 5 to 12 carbon atoms. R⁴ is an alkyl group of 1 to 20 carbon atoms, an alkenyl group of 2 to 20 carbon atoms, a phenyl group, or a 4-methylphenyl group. R⁹ is an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic group of 5 to 20 carbon atoms optionally having a substituent.

Examples of the alkyl group of 1 to 20 carbon atoms in the alkyl group of 1 to 20 carbon atoms optionally having a substituent, of A^{y}, may include a methyl group, an ethyl group, a n-propyl group, an isopropyl group, a n-butyl group, an isobutyl group, a 1-methylpentyl group, a 1-ethylpentyl group, a sec-butyl group, a t-butyl group, a n-pentyl group, an isopentyl group, a neopentyl group, a n-hexyl group, an isohexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, a n-hexadecyl group, a n-heptadecyl group, a n-octadecyl group, a n-nonadecyl group, and a n-icosyl group. The number of carbon atoms in the alkyl group of 1 to 20 carbon atoms optionally having a substituent is preferably 1 to 12, and further preferably 4 to 10.

Examples of the alkenyl group of 2 to 20 carbon atoms in the alkenyl group of 2 to 20 carbon atoms optionally having a substituent, of A^{y}, may include a vinyl group, a propenyl group, an isopropenyl group, a butenyl group, an isobutenyl group, a pentenyl group, a hexenyl group, a heptenyl group, an octenyl group, a decenyl group, an undecenyl group, a dodecenyl group, a tridecenyl group, a tetradecenyl group, a pentadecenyl group, a hexadecenyl group, a heptadecenyl group, an octadecenyl group, a nonadecenyl group, and an icocenyl group. The number of carbon atoms in the alkenyl group of 2 to 20 carbon atoms optionally having a substituent is preferably 2 to 12.

Examples of the cycloalkyl group of 3 to 12 carbon atoms in the cycloalkyl group of 3 to 12 carbon atoms optionally having a substituent, of A^{y}, may include a cyclopropyl group, a cyclobutyl group, a cyclopentyl group, a cyclohexyl group, and a cyclooctyl group.

Examples of the alkynyl group of 2 to 20 carbon atoms in the alkynyl group of 2 to 20 carbon atoms optionally having a substituent, of A^{y}, may include an ethynyl group, a propynyl group, a 2-propynyl group (propargyl group), a butynyl group, a 2-butynyl group, a 3-butynyl group, a pentynyl group, a 2-pentynyl group, a hexynyl group, a 5-hexynyl group, a heptynyl group, an octynyl group, a 2-octynyl group, a nonanyl group, a decanyl group, and a 7-decanyl group.

Examples of the substituents in the alkyl group of 1 to 20 carbon atoms optionally having a substituent and the alkenyl group of 2 to 20 carbon atoms optionally having a substituent, of A^{y}, may include a halogen atom, such as a fluorine atom and a chlorine atom; a cyano group; a substituted amino group, such as a dimethylamino group; an alkoxy group of 1 to 20 carbon atoms, such as a methoxy group, an ethoxy group, an isopropyl group, and a butoxy group; an alkoxy group of 1 to 12 carbon atoms that is substituted by an alkoxy group of 1 to 12 carbon atoms, such as a methoxymethoxy group and a methoxyethoxy group; a nitro group; an aryl group, such as a phenyl group and a naphthyl group; a cycloalkyl group of 3 to 8 carbon atoms, such as a cyclopropyl group, a cyclopentyl group, and a cyclohexyl group; a cycloalkyloxy group of 3 to 8 carbon atoms, such as a cyclopentyloxy group, and a cyclohexyloxy group; a cyclic ether group of 2 to 12 carbon atoms, such as a tetrahydrofuranyl group, a tetrahydropyranyl group, a dioxolanyl group, and a dioxanyl group; an aryloxy group of 6 to 14 carbon atoms, such as a phenoxy group, and a naphthoxy group; a fluoroalkoxy group of 1 to 12 carbon atoms in which at least one is substituted by a fluoro atom, such as a trifluoromethyl group, a pentafluoroethyl group, and —CH₂CF₃; a benzofuryl group; a benzopyranyl group; a benzodioxolyl group; a benzodioxanyl group; —C(═O)—R^{7a}; —C(═O)—OR^{7a}; —SO₂R^{8a}; —SR¹⁰; an alkoxy group of 1 to 12 carbon atoms substituted by —SR¹⁰; and a hydroxyl group. Herein, R^{7a} and R¹⁰ are each independently an alkyl group of 1 to 20 carbon atoms, an alkenyl group of 2 to 20 carbon atoms, a cycloalkyl group of 3 to 12 carbon atoms, or an aromatic hydrocarbon ring group of 6 to 12 carbon atoms. R^{8a} is an alkyl group of 1 to 20 carbon atoms, an alkenyl group of 2 to 20 carbon atoms, a phenyl group, or a 4-methylphenyl group, which are the same as those for R⁴ described above.

Examples of the substituent in the cycloalkyl group of 3 to 12 carbon atoms optionally having a substituent, of A^{y}, may include a halogen atom, such as a fluorine atom and a chlorine atom; a cyano group; a substituted amino group, such as a dimethylamino group; an alkyl group of 1 to 6 carbon atoms, such as a methyl group, an ethyl group, and a propyl group; an alkoxy group of 1 to 6 carbon atoms, such as a methoxy group, an ethoxy group, and an isopropoxy group; a nitro group; an aryl group, such as a phenyl group and a naphthyl group; a cycloalkyl group of 3 to 8 carbon atoms, such as a cyclopropyl group, a cyclopentyl group, and a cyclohexyl group; —C(═O)—R^{7a}; —C(═O)—OR^{7a}; —SO₂R^{8a}; and a hydroxyl group. Herein, R^{7a} and R^{8a} have the same meanings as described above.

Examples of the substituent in the alkynyl group of 2 to 20 carbon atoms optionally having a substituent, of A^{y}, may include subustituents that are the same as the substituents in the alkyl group of 1 to 20 carbon atoms optionally having a substituent and the alkenyl group of 2 to 20 carbon atoms optionally having a substituent.

In the group represented by —C(═O)—R³ of A^{y}, R³ is an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic hydrocarbon ring group of 5 to 12 carbon atoms. Specific examples thereof may include those exemplified as the examples of the alkyl group of 1 to 20 carbon atoms optionally having a substituent, the alkenyl group of 2 to 20 carbon atoms optionally having a substituent, and the cycloalkyl group of 3 to 12 carbon atoms optionally having a substituent, of A^{y}; and the aromatic hydrocarbon ring group of 5 to 12 carbon atoms, among the aromatic hydrocarbon ring groups described in A^{x} described above.

In the group represented by —SO₂—R⁴ of A^{y}, R⁴ is an alkyl group of 1 to 20 carbon atoms, an alkenyl group of 2 to 20 carbon atoms, a phenyl group, or a 4-methylphenyl group. Specific examples of the alkyl group of 1 to 20 carbon atoms and the alkenyl group of 2 to 20 carbon atoms, of R⁴, may include those exemplified as the examples of the alkyl group of 1 to 20 carbon atoms, and the alkenyl group of 2 to 20 carbon atoms, of A^{y} described above.

In the group represented by —C(═S)NH—R⁹ of A^{y}, R⁹ is an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic group of 5 to 20 carbon atoms optionally having a substituent. Specific examples thereof may include those exemplified as the examples of the alkyl group of 1 to 20 carbon atoms optionally having a substituent, the alkenyl group of 2 to 20 carbon atoms optionally having a substituent, and the cycloalkyl group of 3 to 12 carbon atoms optionally having a substituent, of A^{y} described above; and the aromatic hydrocarbon ring group of 5 to 20 carbon atoms and aromatic heteroaromatic ring group of 5 to 20 carbon atoms, among the aromatic hydrocarbon ring groups and aromatic heteroaromatic ring groups described in A^{x} described above.

Examples of the organic group of 2 to 30 carbon atoms having at least one aromatic ring selected from the group consisting of an aromatic hydrocarbon ring and an aromatic heterocyclic ring of A^{y} may include those exemplified as the examples of A^{x} described above.

Among these, A^{y} is preferably a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, —C(═O)—R³, —SO₂—R⁴, or an organic group of 2 to 30 carbon atoms having at least one aromatic ring selected from the group consisting of an aromatic hydrocarbon ring and an aromatic heterocyclic ring, and further preferably a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, an aromatic hydrocarbon ring group of 6 to 12 carbon atoms optionally having a substituent, an aromatic heterocyclic group of 3 to 9 carbon atoms optionally having a substituent, —C(═O)—R³, or a group represented by —SO₂—R⁴. Herein, R³ and R⁴ have the same meanings as described above.

It is preferable that substituents in the alkyl group of 1 to 20 carbon atoms optionally having a substituent, the alkenyl group of 2 to 20 carbon atoms optionally having a substituent, and the alkynyl group of 2 to 20 carbon atoms optionally having a substituent, of A^{y}, are a halogen atom, a cyano group, an alkoxy group of 1 to 20 carbon atoms, an alkoxy group of 1 to 12 carbon atoms that is substituted by an alkoxy group of 1 to 12 carbon atoms, a phenyl group, a cyclohexyl group, a cyclic ether group of 2 to 12 carbon atoms, an aryloxy group of 6 to 14 carbon atoms, a hydroxyl group, a benzodioxanyl group, a phenylsulfonyl group, a 4-methylphenylsulfonyl group, a benzoyl group, or —SR¹⁰. Herein, R¹⁰ has the same meanings as described above.

It is preferable that substituents in the cycloalkyl group of 3 to 12 carbon atoms optionally having a substituent, the aromatic hydrocarbon ring group of 6 to 12 carbon atoms optionally having a substituent, and the aromatic heterocyclic group of 3 to 9 carbon atoms optionally having a substituent, of A^{y}, are a fluorine atom, an alkyl group of 1 to 6 carbon atoms, an alkoxy group of 1 to 6 carbon atoms, or a cyano group.

A^{x} and A^{y} may form a ring together. Examples of the ring may include an unsaturated heterocyclic ring of 4 to 30 carbon atoms optionally having a substituent and an unsaturated carbon ring of 6 to 30 carbon atoms optionally having a substituent.

The aforementioned unsaturated heterocyclic ring of 4 to 30 carbon atoms and the aforementioned unsaturated carbon ring of 6 to 30 carbon atoms are not particularly restricted, and may or may not have aromaticity.

Examples of the ring formed by A^{x} and A^{y} together may include rings shown below. The rings shown below are a moiety of:

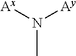

in the formula (I).

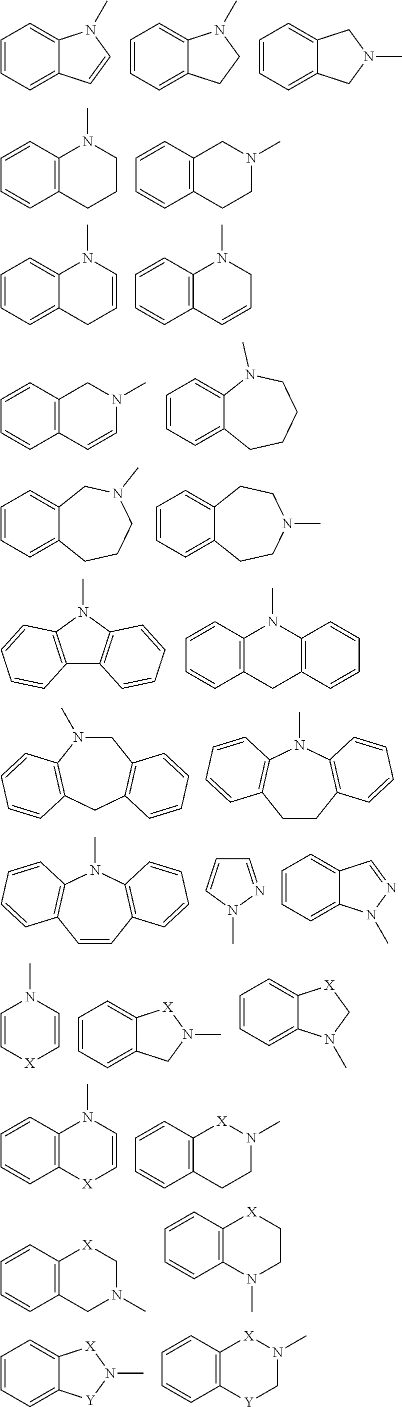

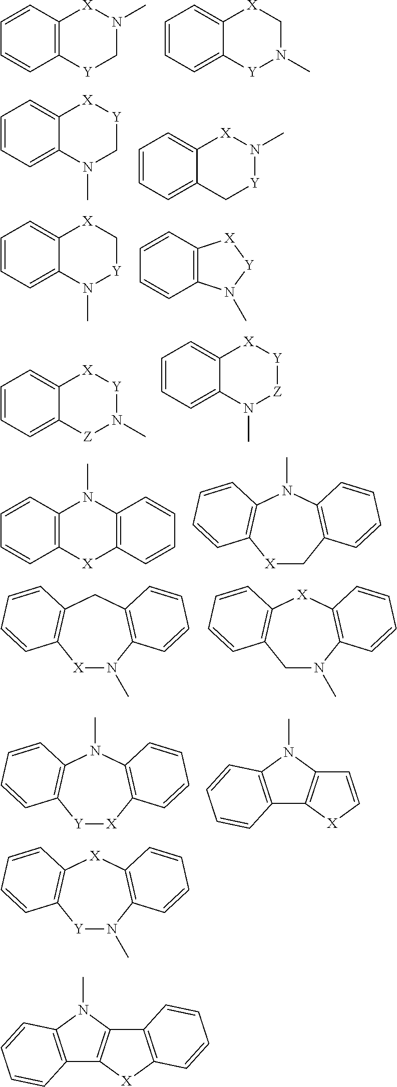

(In the formulae, X, Y, and Z have the same meanings as described above.)

The rings may have a substituent. Examples of the substituent may include those described as the substituent in the aromatic ring of A^{x}.

The total number of π electrons contained in A^{x} and A^{y} is preferably 4 or more, and more preferably 6 or more, and is preferably 24 or less, more preferably 20 or less, and particularly preferably 18 or less from the viewpoint of favorably expressing the desired effect of the present invention.

Examples of preferred combination of A^{x} and A^{y} may include the following combinations (α) and (β).

(α) a combination of A^{x} and A^{y} in which A^{x} is an aromatic hydrocarbon ring group of 4 to 30 carbon atoms or an aromatic heterocyclic group of 4 to 30 carbon atoms, A^{y} is a hydrogen atom, a cycloalkyl group of 3 to 8 carbon atoms, an aromatic hydrocarbon ring group of 6 to 12 carbon atoms optionally having a substituent (a halogen atom, a cyano group, an alkyl group of 1 to 6 carbon atoms, an alkoxy group of 1 to 6 carbon atoms, or a cycloalkyl group of 3 to 8 carbon atoms), an aromatic heterocyclic group of 3 to 9 carbon atoms optionally having a substituent (a halogen atom, an alkyl group of 1 to 6 carbon atoms, an alkoxy group of 1 to 6 carbon atoms, or a cyano group), an alkyl group of 1 to 20 carbon atoms optionally having a substituent, an alkenyl group of 1 to 20 carbon atoms optionally having a substituent, or an alkynyl group of 2 to 20 carbon atoms optionally having a substituent, and the substituent is any of a halogen atom, a cyano group, an alkoxy group of 1 to 20 carbon atoms, an alkoxy group of 1 to 12 carbon atoms that is substituted by an alkoxy group of 1 to 12 carbon atoms, a phenyl group, a cyclohexyl group, a cyclic ether group of 2 to 12 carbon atoms, an aryloxy group of 6 to 14 carbon atoms, a hydroxyl group, a benzodioxanyl group, a benzenesulfonyl group, a benzoyl group, and —SR¹⁰.

(β) a combination of A^{x} and A^{y} in which A^{x} and A^{y} together form an unsaturated heterocyclic ring or an unsaturated carbon ring.

Herein, R¹⁰ has the same meanings as described above.

Examples of more preferred combination of A^{x} and A^{y} may include the following combination (γ).

(γ) a combination of A^{x} and A^{y} in which A^{x} is any of groups having the following structures, A^{x} is a hydrogen atom, a cycloalkyl group of 3 to 8 carbon atoms, an aromatic hydrocarbon ring group of 6 to 12 carbon atoms optionally having a substituent (a halogen atom, a cyano group, an alkyl group of 1 to 6 carbon atoms, an alkoxy group of 1 to 6 carbon atoms, or a cycloalkyl group of 3 to 8 carbon atoms), an aromatic heterocyclic group of 3 to 9 carbon atoms optionally having a substituent (a halogen atom, an alkyl group of 1 to 6 carbon atoms, an alkoxy group of 1 to 6 carbon atoms, or a cyano group), an alkyl group of 1 to 20 carbon atoms optionally having a substituent, an alkenyl group of 1 to 20 carbon atoms optionally having a substituent, or an alkynyl group of 2 to 20 carbon atoms optionally having a substituent, and the substituent is any of a halogen atom, a cyano group, an alkoxy group of 1 to 20 carbon atoms, an alkoxy group of 1 to 12 carbon atoms that is substituted by an alkoxy group of 1 to 12 carbon atoms, a phenyl group, a cyclohexyl group, a cyclic ether group of 2 to 12 carbon atoms, an aryloxy group of 6 to 14 carbon atoms, a hydroxyl group, a benzodioxanyl group, a benzenesulfonyl group, a benzoyl group, and —SR¹⁰. Herein, R¹⁰ has the same meanings as described above.

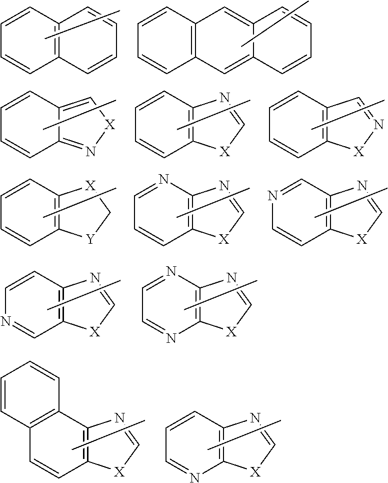

(In the formulae, X and Y have the same meanings as described above.)

Examples of particularly preferred combination of A^{x} and A^{y} may include the following combination (δ).

(δ) a combination of A^{x} and A^{y} in which A^{x} is any of groups having the following structures, A^{y} is a hydrogen atom, a cycloalkyl group of 3 to 8 carbon atoms, an aromatic hydrocarbon ring group of 6 to 12 carbon atoms optionally having a substituent (a halogen atom, a cyano group, an alkyl group of 1 to 6 carbon atoms, an alkoxy group of 1 to 6 carbon atoms, or a cycloalkyl group of 3 to 8 carbon atoms), an aromatic heterocyclic group of 3 to 9 carbon atoms optionally having a substituent (a halogen atom, an alkyl group of 1 to 6 carbon atoms, an alkoxy group of 1 to 6 carbon atoms, or a cyano group), an alkyl group of 1 to 20 carbon atoms optionally having a substituent, an alkenyl group of 1 to 20 carbon atoms optionally having a substituent, or an alkynyl group of 2 to 20 carbon atoms optionally having a substituent, and the substituent is any of a halogen atom, a cyano group, an alkoxy group of 1 to 20 carbon atoms, an alkoxy group of 1 to 12 carbon atoms that is substituted by an alkoxy group of 1 to 12 carbon atoms, a phenyl group, a cyclohexyl group, a cyclic ether group of 2 to 12 carbon atoms, an aryloxy group of 6 to 14 carbon atoms, a hydroxyl group, a benzodioxanyl group, a benzenesulfonyl group, a benzoyl group, and —SR¹⁰. In the following formulae, X has the same meanings as described above. Herein, R¹⁰ has the same meanings as described above.

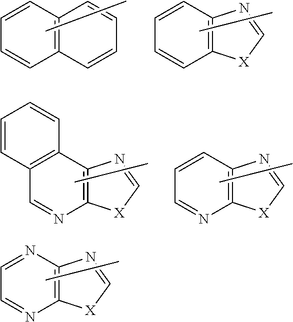

In the formula (I) mentioned above, A¹ is a trivalent aromatic group optionally having a substituent. The trivalent aromatic group may be a trivalent carbocyclic aromatic group or a trivalent heterocyclic aromatic group. From the viewpoint of favorably expressing the desired effect of the present invention, the trivalent aromatic group is preferably the trivalent carbocyclic aromatic group, more preferably a trivalent benzene ring group or a trivalent naphthalene ring group, and further preferably a trivalent benzene ring group or a trivalent naphthalene ring group that is represented by the following formula. In the following formulae, substituents Y¹ and Y² are described for the sake of convenience to clearly show a bonding state (Y¹ and Y² have the same meanings as described above, and the same applies to the following).

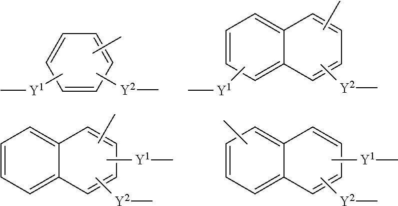

Among these, A¹ is more preferably a group represented by each of the following formulae (A11) to (A25), further preferably a group represented by the formula (A11), (A13), (A15), (A19), or (A23), and particularly preferably a group represented by the formula (A11) or (A23).

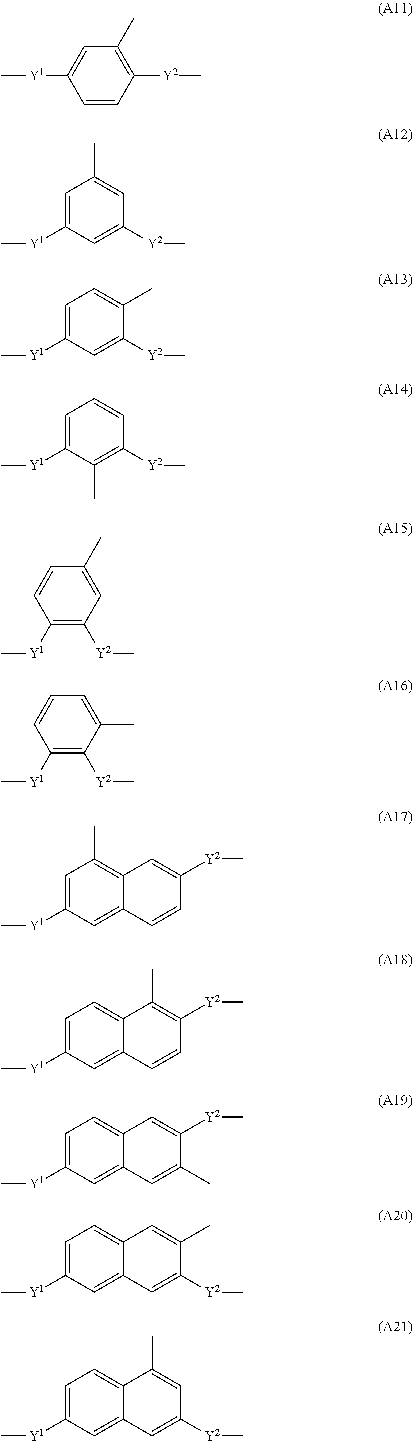

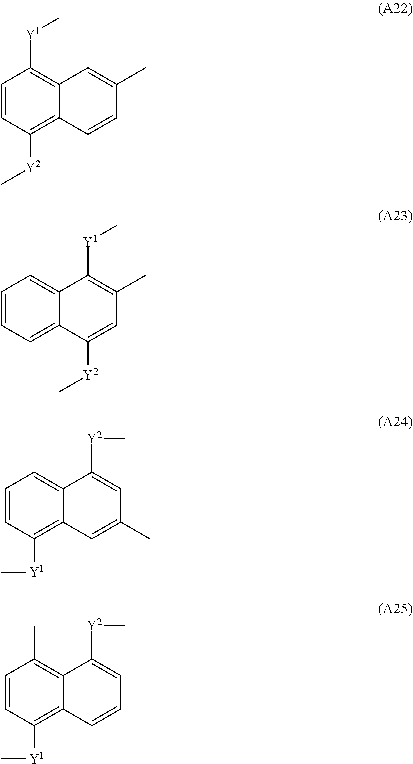

Examples of the substituent that may be included in the trivalent aromatic group of A¹ may include those described as the substituent in the aromatic ring of A^{x} described above. It is preferable that A¹ is a trivalent aromatic group having no substituent.

In the formula (I) mentioned above, A² and A³ are each independently a divalent alicyclic hydrocarbon group of 3 to 30 carbon atoms optionally having a substituent. Examples of the divalent alicyclic hydrocarbon group of 3 to 30 carbon atoms may include a cycloalkanediyl group of 3 to 30 carbon atoms, and a divalent alicyclic fused ring group of 10 to 30 carbon atoms.

Examples of the cycloalkanediyl group of 3 to 30 carbon atoms may include a cyclopropanediyl group; a cyclobutanediyl group, such as a cyclobutane-1,2-diyl group and a cyclobutane-1,3-diyl group; a cyclopentanediyl group, such as a cyclopentane-1,2-diyl group and a cyclopentane-1,3-diyl group; a cyclohexanediyl group, such as a cyclohexane-1,2-diyl group, a cyclohexane-1,3-diyl group, and a cyclohexane-1,4-diyl group; a cycloheptanediyl group, such as a cycloheptane-1,2-diyl group, a cycloheptane-1,3-diyl group, and a cycloheptane-1,4-diyl group; a cyclooctanediyl group, such as a cyclooctane-1,2-diyl group, a cyclooctane-1,3-diyl group, a cyclooctane-1,4-diyl group, and a cyclooctane-1,5-diyl group; a cyclodecanediyl group, such as a cyclodecane-1,2-diyl group, a cyclodecane-1,3-diyl group, a cyclodecane-1,4-diyl group, and a cyclodecane-1,5-diyl group; a cyclododecanediyl group, such as a cyclododecane-1,2-diyl group, a cyclododecane-1,3-diyl group, a cyclododecane-1,4-diyl group, and a cyclododecane-1,5-diyl group; a cyclotetradecanediyl group, such as a cyclotetradecane-1,2-diyl group, a cyclotetradecane-1,3-diyl group, a cyclotetradecane-1,4-diyl group, a cyclotetradecane-1,5-diyl group, and a cyclotetradecane-1,7-diyl group; and a cycloeicosanediyl group, such as a cycloeicosane-1,2-diyl group and a cycloeicosane-1,10-diyl group.

Examples of the divalent alicyclic fused ring group of 10 to 30 carbon atoms may include a decalindiyl group, such as a decalin-2,5-diyl group and a decalin-2,7-diyl group; an adamantanediyl group, such as an adamantane-1,2-diyl group and an adamantane-1,3-diyl group; and a bicyclo[2.2.1]heptanediyl group, such as a bicyclo[2.2.1]heptane-2,3-diyl group, a bicyclo[2.2.1]heptane-2,5-diyl group, and a bicyclo[2.2.1]heptane-2,6-diyl group.

The divalent alicyclic hydrocarbon groups may further have a substituent at any position. Examples of the substituent may include those described as the substituent in the aromatic ring of A^{x} described above.

Among these, A² and A³ are preferably a divalent alicyclic hydrocarbon group of 3 to 12 carbon atoms, more preferably a cycloalkanediyl group of 3 to 12 carbon atoms, further preferably a group represented by each of the following formulae (A31) to (A34), and particularly preferably the group represented by the following formula (A32).

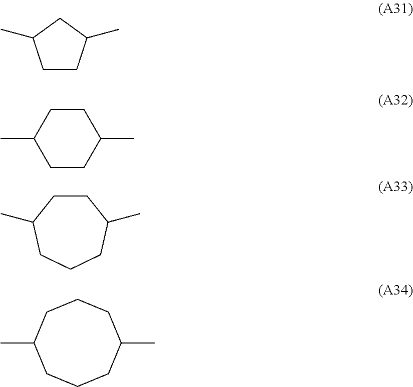

The divalent alicyclic hydrocarbon group of 3 to 30 carbon atoms may exist in forms of cis- and trans-stereoisomers that are on the basis of difference of stereoconfiguration of carbon atoms bonded to Y² and Y³ (or Y² and Y⁴). For example, when the group is a cyclohexane-1,4-diyl group, a cis-isomer (A32a) and a trans-isomer (A32b) may exist, as described below.

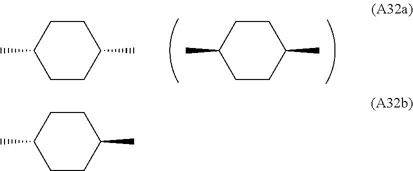

The aforementioned divalent alicyclic hydrocarbon group of 3 to 30 carbon atoms may be a cis-isomer, a trans-isomer, or an isomeric mixture of cis- and trans-isomers. Since the orientation quality is favorable, the group is preferably the trans-isomer or the cis-isomer, and more preferably the trans-isomer.

In the formula (I) mentioned above, A⁴ and A⁵ are each independently a divalent aromatic group of 6 to 30 carbon atoms optionally having a substituent. The aromatic group of A⁴ and A⁵ may be monocyclic or polycyclic. Specific preferable examples of A⁴ and A⁵ are as follows.

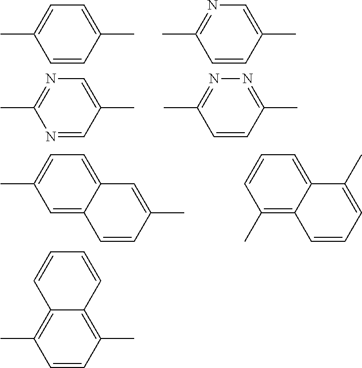

The divalent aromatic groups of A⁴ and A⁵ described above may have a substituent at any position. Examples of the substituent may include a halogen atom, a cyano group, a hydroxyl group, an alkyl group of 1 to 6 carbon atoms, an alkoxy group of 1 to 6 carbon atoms, a nitro group, and a —C(═O)—OR^{8b} group. Herein, R^{8b} is an alkyl group of 1 to 6 carbon atoms. In particular, it is preferable that the substituent is a halogen atom, an alkyl group of 1 to 6 carbon atoms, or an alkoxy group. Of the halogen atoms, a fluorine atom is more preferable, of the alkyl groups of 1 to 6 carbon atoms, a methyl group, an ethyl group, and a propyl group are more preferable, and of the alkoxy groups, a methoxy group and an ethoxy group are more preferable.

Among these, from the viewpoint of favorably expressing the desired effect of the present invention, A⁴ and A⁵ are each independently preferably a group represented by the following formula (A41), (A42), or (A43) and optionally having a substituent, and particularly preferably the group represented by the formula (A41) and optionally having a substituent.

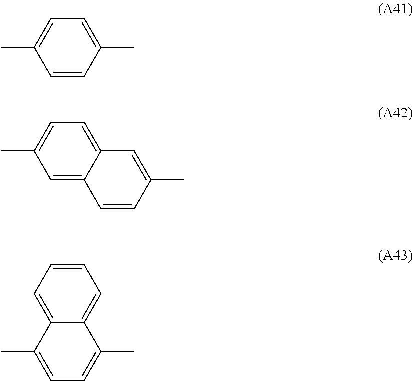

In the formula (I) mentioned above, Q¹ is a hydrogen atom or an alkyl group of 1 to 6 carbon atoms optionally having a substituent. Examples of the alkyl group of 1 to 6 carbon atoms optionally having a substituent may include the alkyl group of 1 to 6 carbon atoms among the alkyl groups of 1 to 20 carbon atoms optionally having a substituent that are described as A^{y} described above. Among these, Q¹ is preferably a hydrogen atom or an alkyl group of 1 to 6 carbon atoms, and more preferably a hydrogen atom or a methyl group.

In the formula (I) mentioned above, m and n are each independently 0 or 1. Among these, m is preferably 1, and n is preferably 1.

The compound (I) may be produced, for example, by the following reaction.

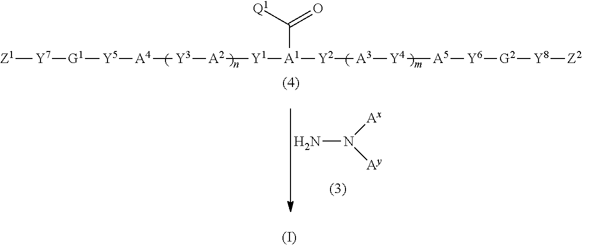

(In the formula, Y¹ to Y⁸, G¹, G², Z¹, Z², A^{x}, A^{y}, A¹ to A⁵, Q¹, m, and n have the same meanings as described above.)

As shown in the aforementioned reaction formula, the compound (I) may be produced by a reaction of a hydrazine compound represented by a formula (3) with a carbonyl compound represented by a formula (4). Hereinafter, the hydrazine compound represented by the formula (3) may be referred to as “hydrazine compound (3)” as appropriate. The carbonyl compound represented by the formula (4) may be referred to as “carbonyl compound (4)” as appropriate.

In the aforementioned reaction, the molar ratio of “the hydrazine compound (3): the carbonyl compound (4)” is preferably 1:2 to 2:1, and more preferably 1:1.5 to 1.5:1. When the compounds are reacted at such a molar ratio, the compound (I) as a target can be highly selectively produced in high yield.

In this case, the reaction system may include an acid catalyst including an organic acid, such as (±)-10-camphorsulfonic acid and p-toluene sulfonic acid; and an inorganic acid, such as hydrochloric acid and sulfuric acid. When the acid catalyst is used, the reaction time may be shortened, and the yield may be improved. The amount of the acid catalyst is usually 0.001 mol to 1 mol relative to 1 mol of the carbonyl compound (4). The acid catalyst as it is may be mixed in the reaction system. Alternatively, the acid catalyst to be mixed may be in a solution form in which the acid catalyst is dissolved in an appropriate solution.

As the solvent for use in the reaction, a solvent inert to the reaction may be used. Examples of the solvent may include an alcohol-based solvent, such as methyl alcohol, ethyl alcohol, n-propyl alcohol, isopropyl alcohol, n-butyl alcohol, isobutyl alcohol, sec-butyl alcohol, and t-butyl alcohol; an ether-based solvent, such as diethyl ether, tetrahydrofuran, 1,2-dimethoxyethane, 1,4-dioxane, and cyclopentyl methyl ether; an ester-based solvent, such as ethyl acetate, propyl acetate, and methyl propionate; an aromatic hydrocarbon-based solvent, such as benzene, toluene, and xylene; an aliphatic hydrocarbon-based solvent, such as n-pentane, n-hexane, and n-heptane; an amide-based solvent, such as N,N-dimethylformamide, N-methylpyrrolidone, and hexamethylphosphoric triamide; a sulfur-containing solvent, such as dimethylsulfoxide, and sulfolane; and a mixed solvent of two or more types thereof. Among these, the alcohol-based solvent, the ether-based solvent, and a mixed solvent of the alcohol-based solvent and the ether-based solvent are preferable.

The amount of the solvent used is not particularly limited, and may be determined in consideration of type of compound to be used, reaction scale, and the like. The specific amount of the solvent used is usually 1 g to 100 g relative to 1 g of the hydrazine compound (3).

The reaction can smoothly proceed in a temperature range that is usually −10° C. or higher and equal to or lower than the boiling point of the solvent used. The reaction time of each reaction may vary depending on the reaction scale, and is usually several minutes to several hours.

The hydrazine compound (3) may be produced as follows.

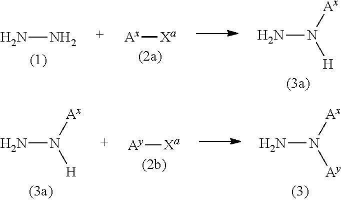

(wherein, A^{x} and A^{y} have the same meanings as described above, and X^{a} is a leaving group, such as a halogen atom, a methanesulfonyloxy group, and a p-toluenesulfonyloxy group.)

As shown in the aforementioned reaction formula, a corresponding hydrazine compound (3a) can be obtained by a reaction of a compound represented by a formula (2a) with hydrazine (1) in an appropriate solvent. In this reaction, the molar ratio of “the compound (2a): the hydrazine (1)” is preferably 1:1 to 1:20, and more preferably 1:2 to 1:10. Further, the hydrazine compound (3a) can be reacted with a compound represented by a formula (2b) to obtain the hydrazine compound (3).

As hydrazine (1), hydrazine monohydrate may be usually used. As hydrazine (1), a commercially available product as it is may be used.

As the solvent for use in this reaction, a solvent inert to the reaction may be used. Examples of the solvent may include an alcohol-based solvent, such as methyl alcohol, ethyl alcohol, n-propyl alcohol, isopropyl alcohol, n-butyl alcohol, isobutyl alcohol, sec-butyl alcohol, and t-butyl alcohol; an ether-based solvent, such as diethyl ether, tetrahydrofuran, 1,2-dimethoxyethane, 1,4-dioxane, and cyclopentyl methyl ether; an aromatic hydrocarbon-based solvent, such as benzene, toluene, and xylene; an aliphatic hydrocarbon-based solvent, such as n-pentane, n-hexane, and n-heptane; an amide-based solvent, such as N,N-dimethylformamide, N-methylpyrrolidone, and hexamethylphosphoric triamide; a sulfur-containing solvent, such as dimethylsulfoxide, and sulfolane; and a mixed solvent of two or more types thereof. Among these, the alcohol-based solvent, the ether-based solvent, and a mixed solvent of the alcohol-based solvent and the ether-based solvent are preferable.

The amount of the solvent used is not particularly limited, and may be determined in consideration of type of compound to be used, reaction scale, and the like. For example, the specific amount of the solvent used is usually 1 g to 100 g relative to 1 g of hydrazine.

The reaction can smoothly proceed in a temperature range that is usually −10° C. or higher and equal to or lower than the boiling point of the solvent used. The reaction time of each reaction may vary depending on the reaction scale, and is usually several minutes to several hours.

The hydrazine compound (3) may also be produced by reducing a diazonium salt (5) through a known method, as described below.

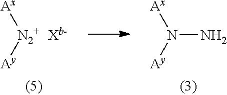

In the formula (5), A^{x} and A^{y} have the same meanings as described above, and X^{b-} is an anion that is a counter ion of diazonium. Examples of X^{b-} may include an inorganic anion, such as a hexafluorophosphate ion, a fluoroborate ion, a chloride ion, and a sulfate ion; and an organic anion, such as a polyfluoroalkylcarbonate ion, a polyfluoroalkylsulfonate ion, a tetraphenylborate ion, an aromatic carboxylate ion, and an aromatic sulfonate ion.

Examples of the reducing agent used in the aforementioned reaction may include a metal salt reducing agent. The metal salt reducing agent is generally a compound containing low-valent metal or a compound composed of a metal ion and a hydride source (see “Yuki Gosei Jikkenhou Handbook (Organic synthesis experimental method handbook)”, 1990, edited by The Society of Synthetic Organic Chemistry, Japan, published by Maruzen Co., Ltd., p. 810).

Examples of the metal salt reducing agent may include NaAlH₄, NaAlHₚ(Or)_{q} (wherein p and q are each independently an integer of 1 to 3, p+q=4, and r is an alkyl group of 1 to 6 carbon atoms), LiAlH₄, iBu₂AlH, LiBH₄, NaBH₄, SnCl₂, CrCl₂, and TiCl₃. Herein, “iBu” represents an isobutyl group.

In the reduction reaction, a known reaction condition may be adopted. For example, the reaction may be performed under conditions described in documents including Japanese Patent Application Laid-Open No. 2005-336103 A, Shin Jikken Kagaku Koza (New course of experimental chemistry), 1978, published by Maruzen Co., Ltd., vol. 14, and Jikken Kagaku Koza (Course of experimental chemistry), 1992, published by Maruzen Co., Ltd., vol. 20.

The diazonium salt (5) may be produced from a compound such as aniline by an ordinary method.

The carbonyl compound (4) may be produced, for example, by appropriately bonding and modifying a plurality of known compounds having a desired structure through any combination of reactions of forming an ether linkage (—O—), an ester linkage (—C(═O)—O— and —O—C(═O)—), a carbonate linkage (—O—C(═O)—O—), and an amide linkage (—C(═O)NH— and —NH—C(═O)—).

An ether linkage may be formed as follows.

(i) A compound represented by a formula: D1-hal (hal is a halogen atom, and the same applies to the following) and a compound represented by a formula: D2-OMet (Met is an alkaline metal (mainly sodium), and the same applies to the following) are mixed and condensed (Williamson synthesis). In the formulae, D1 and D2 are an optional organic group (the same applies to the following).

(ii) A compound represented by a formula: D1-hal and a compound represented by a formula: D2-0H are mixed in the presence of a base, such as sodium hydroxide and potassium hydroxide and condensed.

(iii) A compound represented by a formula: D1-J (J is an epoxy group) and a compound represented by a formula: D2-0H are mixed in the presence of a base, such as sodium hydroxide and potassium hydroxide and condensed.

(iv) A compound represented by a formula: D1-OFN (OFN is a group having an unsaturated bond) and a compound represented by a formula: D2-OMet are mixed in the presence of a base, such as sodium hydroxide and potassium hydroxide and subjected to an addition reaction.

(v) A compound represented by a formula: D1-hal and a compound represented by a formula: D2-OMet are mixed in the presence of copper or cuprous chloride and condensed (Ullmann condensation).

An ester linkage and an amide linkage may be formed as follows.

(vi) A compound represented by a formula: D1-COOH and a compound represented by a formula: D2-OH or D2-NH₂ are subjected to dehydration condensation in the presence of a dehydration condensation agent (N,N-dicyclohexylcarbodiimide, etc.).

(vii) A compound represented by a formula: D1-COOH is reacted with a halogenating agent to obtain a compound represented by a formula: D1-CO-hal, and the compound is reacted with a compound represented by a formula: D2-0H or D2-NH₂ in the presence of a base.

(viii) A compound represented by a formula: D1-COOH is reacted with an acid anhydride to obtain a mixed acid anhydride, and the mixed acid anhydride is reacted with a compound represented by a formula: D2-OH or D2-NH₂.

(ix) A compound represented by a formula: D1-COOH and a compound represented by a formula: D2-OH or D2-NH₂ are subjected to dehydration condensation in the presence of an acid catalyst or a base catalyst.

More specifically, the carbonyl compound (4) may be produced through a process shown in the following reaction formula.

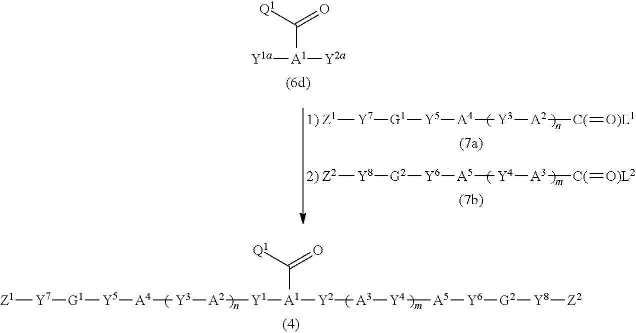

(In the formula, Y¹ to Y⁸, G¹, G², Z¹, Z², A¹ to A⁵, Q¹, m, and n have the same meanings as described above; L¹ and L² are each independently a leaving group, such as a hydroxyl group, a halogen atom, a methanesulfonyloxy group, and a p-toluenesulfonyloxy group; —Y^{1a} is a group that is capable of being reacted with -L¹ to be —Y¹—; and —Y^{2′} is a group that is capable of being reacted with -L² to be —Y²—.)

As shown in the aforementioned reaction formula, the carbonyl compound (4) may be produced by reacting a compound represented by a formula (6d) with a compound represented by a formula (7a) followed by a compound represented by a formula (7b) by using a reaction of forming an ether linkage (—O—), an ester linkage (—C(═O)—O— and —O—C(═O)—), or a carbonate linkage (—O—C(═O)—O—).

Specifically, a method for producing a compound (4′) in which Y¹ is a group represented by a formula: Y¹¹—C(═O)—O— and a group represented by a formula: Z²—Y⁸-G²-Y⁶-A⁵-(Y⁴-A³)ₘ-Y²— is the same as a group represented by a formula: Z¹—Y⁷-G¹-Y⁵-A⁴-(Y³-A²)ₙ-Y¹— is as follows.

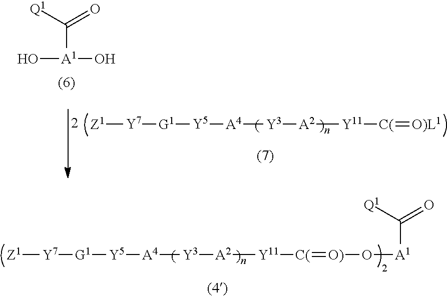

(In the formula, Y³, Y⁵, Y⁷, G¹, Z¹, A¹, A², A⁴, Q¹, n, and L¹ have the same meanings as described above; Y¹¹ is a group having a structure with which Y¹¹—C(═O)—O— corresponds to Y¹; and Y¹ has the same meanings as described above.)

As shown in the aforementioned reaction formula, the compound (4′) may be produced by a reaction of a dihydroxy compound represented by a formula (6) (compound (6)) with a compound represented by a formula (7) (compound (7)). In the aforementioned reaction, the molar ratio of “the compound (6): the compound (7)” is preferably 1:2 to 1:4, and more preferably 1:2 to 1:3. When the compounds are reacted at such a molar ratio, the compound (4′) as a target can be highly selectively produced in high yield.

When the compound (7) is a compound in which L¹ is a hydroxyl group (carboxylic acid), the reaction may be performed in the presence of a dehydration condensation agent such as 1-ethyl-3-(3-dimethylaminopropyl)carbodiimide hydrochloride and dicyclohexyl carbodiimide, to obtain a target compound. The amount of the dehydration condensation agent used is usually 1 mol to 3 mol relative to 1 mol of the compound (7).

When the compound (7) is a compound in which L¹ is a hydroxyl group (carboxylic acid), the reaction may be performed in the presence of sulfonyl halide such as methanesulfonyl chloride and p-toluenesulfonyl chloride, and a base such as triethylamine, diisopropylethylamine, pyridine, and 4-(dimethylamino)pyridine, to obtain a target compound. The amount of the sulfonyl halide used is usually 1 mol to 3 mol relative to 1 mol of the compound (7). The amount of base used is usually 1 mol to 3 mol relative to 1 mol of the compound (7). In this case, a compound in which L¹ in the formula (7) is a sulfonyloxy group (mixed acid anhydride) may be isolated, before performing the subsequent reaction.

When the compound (7) is a compound in which L¹ is a halogen atom (acid halide), the reaction may be performed in the presence of a base to obtain a target compound. Examples of the base may include an organic base such as triethylamine and pyridine; and an inorganic base such as sodium hydroxide, sodium carbonate, and sodium hydrogen carbonate. The amount of base used is usually 1 mol to 3 mol relative to 1 mol of the compound (7).

Examples of a solvent for use in the reaction may include a chlorinated solvent, such as chloroform, and methylene chloride; an amide-based solvent, such as N-methylpyrrolidone, N,N-dimethylformamide, N,N-dimethylacetamide, and hexamethylphosphoric triamide; an ether-based solvent, such as 1,4-dioxane, cyclopentyl methyl ether, tetrahydrofuran, tetrahydropyran, and 1,3-dioxolane; a sulfur-containing solvent, such as dimethylsulfoxide, and sulfolane; an aromatic hydrocarbon-based solvent, such as benzene, toluene, and xylene; an aliphatic hydrocarbon-based solvent, such as n-pentane, n-hexane, and n-octane; an alicyclic hydrocarbon-based solvent, such as cyclopentane, and cyclohexane; and a mixed solvent of two or more types thereof.

The amount of the solvent used is not particularly limited, and may be determined in consideration of type of compound to be used, reaction scale, and the like. The specific amount of the solvent used is usually 1 g to 50 g relative to 1 g of the hydroxy compound (6).

Most of compounds (6) are known substances, and may be produced by known methods. For example, the compound (6) may be produced by a process shown in the following reaction formula (see International publication WO2009/042544 and The Journal of Organic Chemistry, 2011, 76, 8082-8087). A product commercially available as the compound (6) may be used with, if desired, purification.

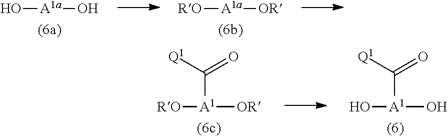

(wherein A¹ and Q¹ have the same meanings as described above; A^{1a} is a divalent aromatic group that is capable of being formylated or acylated to form A¹; and R′ is a protecting group of a hydroxyl group, such as an alkyl group of 1 to 6 carbon atoms such as a methyl group and an ethyl group and an alkoxyalkyl group of 2 to 6 carbon atoms such as a methoxymethyl group.)

As shown in the aforementioned reaction formula, a hydroxyl group of a dihydroxy compound represented by a formula (6a) (1,4-dihydroxybenzene, 1,4-dihydroxynaphthalene, etc.) is alkylated to obtain a compound represented by a formula (6b). Subsequently, an ortho position of an OR′ group is formylated or acylated by a known method, to obtain a compound represented by a formula (6c). The obtained compound may be subjected to deprotection (dealkylation), to produce the compound (6) as a target.

The product commercially available as the compound (6) as it is may be used or with, if desired, purification.

Most of compounds (7) are known compounds, and may be produced, for example, by appropriately bonding and modifying a plurality of known compounds having a desired structure through any combination of reactions of forming an ether linkage (—O—), an ester linkage (—C(═O)—O— and —O—C(═O)—), a carbonate linkage (—O—C(═O)—O—), and an amide linkage (—C(═O)NH— and —NH—C(═O)—).

For example, when the compound (7) is a compound represented by the following formula (7′) (compound (7′)), the compound (7′) may be produced as follows, using a dicarboxylic acid represented by a formula (9′) (compound (9′)).

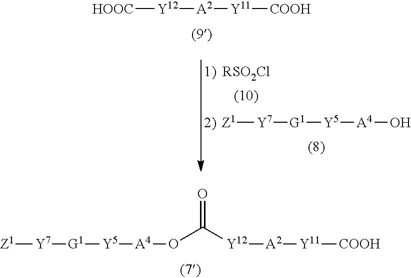

(In the formula, Y⁵, Y⁷, G¹, Z¹, A², A⁴, and Y^{1l} have the same meanings as described above; Y¹² is a group having a structure with which —O—C(═O)—Y¹² corresponds to Y³; and R is an alkyl group, such as a methyl group and an ethyl group, or an aryl group optionally having a substituent, such as a phenyl group and a p-methylphenyl group.)

The compound (9′) is first reacted with sulfonyl chloride represented by a formula (10) in the presence of a base such as triethylamine or 4-(dimethylamino)pyridine. Subsequently, to the reaction mixture, a compound (8) and a base such as triethylamine or 4-(dimethylamino)pyridine are added to perform a reaction.

The amount of sulfonyl chloride used is usually 0.5 equivalents to 0.7 equivalents relative to 1 equivalent of the compound (9′).

The amount of compound (8) used is usually 0.5 equivalents to 0.6 equivalents relative to 1 equivalent of the compound (9′).

The amount of base used is usually 0.5 equivalents to 0.7 equivalents relative to 1 equivalent of the compound (9′).

The reaction temperature is 20° C. to 30° C., and the reaction time may vary depending on the reaction scale, and the like, and is several minutes to several hours.

Examples of the solvent for use in the aforementioned reaction may include those exemplified as the examples of the solvent that may be used for producing the compound (4′). Among these, an ether solvent is preferable.

The amount of the solvent used is not particularly limited, and may be determined in consideration of type of compound to be used, reaction scale, and the like. For example, the specific amount of the solvent used is usually 1 g to 50 g relative to 1 g of the hydroxy compound (9′).

In any of the reactions, a usual post-treatment operation in organic synthesis chemistry may be performed after completion of the reactions. If desired, a known separation and purification method such as column chromatography, recrystallization, and distillation may be performed to isolate a target compound.

The structure of the target compound may be identified by measurement such as NMR spectrometry, IR spectrometry, and mass spectrometry, and elemental analysis.

The molecular weight of the polymerizable liquid crystal compound is preferably 300 or more, more preferably 700 or more, and particularly preferably 1,000 or more, and is preferably 2,000 or less, more preferably 1,700 or less, and particularly preferably 1,500 or less. The polymerizable liquid crystal compound that has the aforementioned molecular weight represents that the polymerizable liquid crystal compound is a monomer. By using the polymerizable liquid crystal compound that is not a polymer but a monomer, application properties of the liquid crystal composition can be particularly improved.

As the polymerizable liquid crystal compound, one type thereof may be solely used, and two or more types thereof may also be used in combination at any ratio.

(2.2.2. Surfactant)

The liquid crystal composition contains a surfactant containing fluorine atoms in the molecule. The surfactant can make application properties of the liquid crystal composition favorable. Therefore, surface state of the liquid crystal cured layer as the layer of the cured product obtained by curing the liquid crystal composition can be improved. Accordingly, uniformity of thickness, orientation quality, and retardation of the liquid crystal cured layer can be improved.

The ratio of the fluorine atoms in the molecule of the surfactant is preferably 1% by weight or more, and is preferably 30% by weight or less, and more preferably 15% by weight or less. When the ratio of the fluorine atoms in the molecule of the surfactant is equal to or more than the lower limit value of the aforementioned range, surface state and orientation quality of the liquid crystal cured layer can be improved. When the ratio of the fluorine atoms in the molecule of the surfactant is equal to or less than the upper limit value of the aforementioned range, surface state and orientation quality of the liquid crystal cured layer can be improved. Further, a liquid crystal cured layer with suppressed dotted blotting and unevenness under observation with irradiation with an HID lamp can be easily formed.

The ratio of the fluorine atom in the molecule of the surfactant may be measured by the following method.

The surfactant as a sample is weighed, and combusted in a combustion tube of an analyzer. A gas generated by the combustion is absorbed by an appropriate solution, to obtain an absorbing liquid. Subsequently, a part of the absorbing liquid is analyzed by ion chromatography. As a result, the ratio of the fluorine atom in the molecule of the surfactant can be measured.

It is preferable that the surfactant containing a fluorine atom in the molecule contains a fluoroalkyl group. This fluoroalkyl group is preferably a perfluoroalkyl group or a perfluoroalkenyl group, and particularly preferably a —C₆F₁₃ group or a hexafluoropropylene trimer group, from the viewpoint of significantly exerting effects, such as improvement of surface state, improvement of orientation quality, suppression of phase difference unevenness, and suppression of thickness unevenness.

As the surfactant, a surfactant having an oligomer structure having a repeating unit, in which the number of the repeating unit contained in the molecule of the surfactant is two or more, may be used, or a surfactant having a monomer structure containing no repeating unit may be used.

As the surfactant, a non-polymerizable surfactant may be used, or a polymerizable surfactant may be used. The polymerizable surfactant is capable of being polymerized during polymerization of the polymerizable liquid crystal compound. Therefore, the polymerizable surfactant is usually contained as a part of molecule of a polymer in the liquid crystal cured layer.

Examples of the surfactant containing a fluorine atom as described above may include SURFLON series available from AGC Seimi Chemical Co., Ltd. (S242, 5386, etc.), MEGAFACE available from DIC Corporation (F251, F554, F556, F562, RS-75, RS-76-E, etc.), and FTERGENT series available from NEOS COMPANY LIMITED (FTX601AD, FTX602A, FTX601ADH2, FTX650A, etc.). As the surfactant, one type thereof may be solely used, and two or more types thereof may also be used in combination at any ratio.

The amount of the surfactant containing a fluorine atom is preferably 0.05 parts by weight or more, more preferably 0.1 parts by weight or more, and particularly preferably 0.3 parts by weight or more, and is preferably 5.0 parts by weight or less, more preferably 1.0 part by weight or less, still more preferably 0.7 part by weight or less, and particularly preferably less than 0.5 parts by weight, relative to 100 parts by weight of the polymerizable liquid crystal compound. When the amount of the surfactant is equal to or more than the lower limit value of the aforementioned range, the applying property of the liquid crystal composition onto a substrate can be improved. When it is equal to or less than the upper limit value of the aforementioned range, the surface state of the liquid crystal composition can be improved while the orientation quality is kept.

[2.2.3. Optional Components]

The liquid crystal composition may further contain an optional component in combination with the polymerizable liquid crystal compound and the surfactant.

For example, the liquid crystal composition may contain a sovent. As the solvent, a solvent capable of dissolving the polymerizable liquid crystal compound is preferable. As such a solvent, an organic solvent is usually used. Examples of the organic solvent may include a ketone solvent, such as cyclopentanone, cyclohexanone, methyl ethyl ketone, acetone, and methyl isobutyl ketone; an acetic acid ester solvent, such as butyl acetate, and amyl acetate; a halogenated hydrocarbon solvent, such as chloroform, dichloromethane, and dichloroethane; an ether solvent, such as 1,4-dioxane, cyclopentyl methyl ether, tetrahydrofuran, tetrahydropyran, 1,3-dioxolane, and 1,2-dimethoxyethane; and an aromatic hydrocarbon-based solvent, such as toluene, xylene, and mesitylene.

As the solvent, one type thereof may be solely used, and two or more types thereof may also be used in combination at any ratio as a mixed solvent. For example, it is preferable that a ketone solvent such as cyclopentanone and an ether solvent such as 1,3-dioxolane are used in combination. In a case of such a combination, the ratio by weight of the ketone solvent relative to the ether solvent (ketone solvent/ether solvent) is preferably 10/90 or more, more preferably 30/70 or more, and particularly preferably 40/60 or more, and is preferably 90/10 or less, more preferably 70/30 or less, and particularly preferably 50/50 or less. When the ketone solvent and the ether solvent are used at the aforementioned ratio by weight, occurrence of defects during applying can be suppressed.

The boiling point of the solvent is preferably 60° C. to 250° C., and more preferably 60° C. to 150° C. from the viewpoint of excellent handleability.

The amount of the solvent is preferably 300 parts by weight or more, more preferably 350 parts by weight or more, and particularly preferably 400 parts by weight or more, and is preferably 700 parts by weight or less, more preferably 600 part by weight or less, and particularly preferably 500 parts by weight or less, relative to 100 parts by weight of the polymerizable liquid crystal compound. When the amount of the solvent is equal to or more than the lower limit value of the aforementioned range, generation of undesirable substance can be suppressed. When it is equal to or less than the upper limit value of the aforementioned range, drying load can be decreased.

For example, the liquid crystal composition may contain a polymerization initiator. The polymerization initiator may be selected depending on the type of the polymerizable liquid crystal compound. For example, when the polymerizable liquid crystal compound is radically polymerizable, a radical polymerization initiator may be used. Further, when the polymerizable liquid crystal compound is anionically polymerizable, an anionic polymerization initiator may be used. When the polymerizable liquid crystal compound is cationically polymerizable, a cationic polymerization initiator may be used.

As the radical polymerization initiator, any of a thermal radical generator that is a compound that generates active species capable of initiating polymerization of the polymerizable liquid crystal compound by heating; and a photo-radical generator that is a compound that generates active species capable of initiating polymerization of the polymerizable liquid crystal compound by exposure to exposure light, such as visible light rays, ultraviolet rays (i-line, etc.), far-ultraviolet rays, an electron beam, and a X-ray may be used. Among these, as the radical polymerization initiator, a photo-radical generator is suitable.

Examples of the photo-radical generator may include an acetophenone-based compound, a biimidazole-based compound, a triazine-based compound, an O-acyl oxime-based compound, an onium salt-based compound, a benzoin-based compound, a benzophenone-based compound, an α-diketone-based compound, a polynuclear quinone-based compound, a xanthone-based compound, a diazo-based compound, and an imide sulfonate-based compound. These compounds is capable of generating one or both of active radical and active acid by light exposure.

Specific examples of the acetophenone-based compound may include 2-hydroxy-2-methyl-1-phenylpropan-1-one, 2-methyl-1-[4-(methylthio)phenyl]-2-morpholinopropan-1-one, 2-benzyl-2-dimethylamino-1-(4-morpholinophenyl)-butan-1-one, 1-hydroxycyclohexyl phenyl ketone, 2,2-dimethoxy-1,2-diphenylethan-1-one, 1,2-octanedione, and 2-benzyl-2-dimethylamino-4′-morpholinobutyrophenone.

Specific examples of the biimidazole-based compound may include 2,2′-bis(2-chlorophenyl)-4,4′,5,5′-tetrakis(4-ethoxycarbonylphenyl)-1,2′-biimidazole, 2,2′-bis(2-bromophenyl)-4,4′,5,5′-tetrakis(4-ethoxycarbonylphenyl)-1,2′-biimidazole, 2,2′-bis(2-chlorophenyl)-4,4′,5,5′-tetraphenyl-1,2′-biimidazole, 2,2′-bis(2,4-dichlorophenyl)-4,4′,5,5′-tetraphenyl-1,2′-biimidazole, 2,2′-bis(2,4,6-trichlorophenyl)-4,4′,5,5′-tetraphenyl-1,2′-biimidazole, 2,2′-bis(2-bromophenyl)-4,4′,5,5′-tetraphenyl-1,2′-biimidazole, 2,2′-bis(2,4-dibromophenyl)-4,4′,5,5′-tetraphenyl-1,2′-biimidazole, and 2,2′-bis(2,4,6-tribromophenyl)-4,4′,5,5′-tetraphenyl-1,2′-biimidazole.

When the biimidazole-based compound is used as the polymerization initiator, the sensitivity can be further improved by use of a hydrogen donor in combination with the biimidazole-based compound. Herein, the “hydrogen donor” means a compound capable of donating a hydrogen atom to a radical generated from the biimidazole-based compound by light exposure. The hydrogen donor is preferably a mercaptane-based compound or an amine-based compound, which are shown below.

Examples of the mercaptane-based compound may include 2-mercaptobenzothiazole, 2-mercaptobenzoxazole, 2-mercaptobenzimidazole, 2,5-dimercapto-1,3,4-thiadiazole, and 2-mercapto-2,5-dimethylaminopyridine. Examples of the amine-based compound may include 4,4′-bis(dimethylamino)benzophenone, 4,4′-bis(diethylamino)benzophenone, 4-diethylaminoacetophenone, 4-dimethylaminopropiophenone, ethyl-4-dimethylaminobenzoate, 4-dimethylaminobenzoic acid, and 4-dimethylaminobenzonitrile.

Examples of the triazine-based compound may include a triazine-based compound having a halomethyl group, such as 2,4,6-tris(trichloromethyl)-s-triazine, 2-methyl-4,6-bis(trichloromethyl)-s-triazine, 2-[2-(5-methylfuran-2-yl)ethenyl]-4,6-bis(trichloromethyl)-s-triazine, 2-[2-(furan-2-yl)ethenyl]-4,6-bis(trichloromethyl)-s-triazine, 2-[2-(4-diethylamino-2-methylphenyl)ethenyl]-4,6-bis(trichloromethyl)-s-triazine, 2-[2-(3,4-dimethoxyphenyl)ethenyl]-4,6-bis(trichloromethyl)-s-triazine, 2-(4-methoxyphenyl)-4,6-bis(trichloromethyl)-s-triazine, 2-(4-ethoxystyryl)-4,6-bis(trichloromethyl)-s-triazine, and 2-(4-n-butoxyphenyl)-4,6-bis(trichloromethyl)-s-triazine.

Specific examples of the O-acyl oxime-based compound may include 1-[4-(phenylthio)phenyl]-heptane-1,2-dione 2-(0-benzoyloxime), 1-[4-(phenylthio)phenyl]-octane-1,2-dione 2-(0-benzoyloxime), 1-[4-(benzoyl)phenyl]-octane-1,2-dione 2-(0-benzoyloxime), 1-[9-ethyl-6-(2-methylbenzoyl)-9H-carbazol-3-yl]-ethanone 1-(0-acetyloxime), 1-[9-ethyl-6-(3-methylbenzoyl)-9H-carbazol-3-yl]-ethanone 1-(0-acetyloxime), 1-(9-ethyl-6-benzoyl-9H-carbazol-3-yl)-ethanone 1-(0-acetyloxime), ethanone-1-[9-ethyl-6-(2-methyl-4-tetrahydrofuranylbenzoyl)-9.H.-carbazol-3-yl]-1-(0-acetyloxime), ethanone-1-[9-ethyl-6-(2-methyl-4-tetrahydropyranylbenzoyl)-9.H.-carbazol-3-yl]-1-(0-acetyloxime), ethanone-1-[9-ethyl-6-(2-methyl-5-tetrahydrofuranylbenzoyl)-9.H.-carbazol-3-yl]-1-(0-acetyloxime), ethanone-1-[9-ethyl-6-(2-methyl-5-tetrahydropyranylbenzoyl)-9.H.-carbazol-3-yl]-1-(0-acetyloxime), ethanone-1-[9-ethyl-6-{2-methyl-4-(2,2-dimethyl-1,3-dioxolanyl)benzoyl}-9.H.-carbazol-3-yl]-1-(0-acetyloxime), ethanone-1-[9-ethyl-6-(2-methyl-4-tetrahydrofuranylmethoxybenzoyl)-9.H.-carbazol-3-yl]-1-(0-acetyloxime), ethanone-1-[9-ethyl-6-(2-methyl-4-tetrahydropyranylmethoxybenzoyl)-9.H.-carbazol-3-yl]-1-(0-acetyloxime), ethanone-1-[9-ethyl-6-(2-methyl-5-tetrahydrofuranylmethoxybenzoyl)-9.H.-carbazol-3-yl]-1-(0-acetyloxime), ethanone,1-[9-ethyl-6-(2-methylbenzoyl)-9H-carbazol-3-yl]-1-(0-acetyloxime), ethanone-1-[9-ethyl-6-(2-methyl-5-tetrahydropyranylmethoxybenzoyl)-9.H.-carbazol-3-yl]-1-(O-acetyloxime), and ethanone-1-[9-ethyl-6-{2-methyl-4-(2,2-dimethyl-1,3-dioxolanyl)methoxybenzoyl}-9.H.-carbazol-3-yl]-1-(0-acetyloxime).

As the photo-radical generator, a commercially available product as it is may be used. Specific examples thereof may include trade name: Irgacure907, Irgacure184, Irgacure369, Irgacure651, Irgacure819, Irgacure907, Irgacure379, and Irgacure OXE02, available from BASF, and trade name: ADEKA OPTOMER N1919 available from ADEKA CORPORATION.

Examples of the anionic polymerization initiator may include an alkyl lithium compound; a monolithium salt or a monosodium salt of biphenyl, naphthalene, and pyrene; and a polyfunctional initiator such as a dilithium salt, and a trilithium salt.

Examples of the cationic polymerization initiator may include a protonic acid, such as sulfuric acid, phosphoric acid, perchloric acid, and trifluoromethanesulfonic acid; Lewis acids, such as boron trifluoride, aluminum chloride, titanium tetrachloride, and tin tetrachloride; and an aromatic onium salt, and a combination of an aromatic onium salt with a reducing agent.

As the polymerization initiator, one type thereof may be solely used, and two or more types thereof may also be used in combination at any ratio.

The amount of the polymerization initiator is preferably 0.1 parts by weight or more, and more preferably 0.5 parts by weight or more, and is preferably 30 parts by weight or less, and more preferably 10 parts by weight or less, relative to 100 parts by weight of the polymerizable liquid crystal compound. When the amount of the polymerization initiator falls within the aforementioned range, polymerization of the polymerizable liquid crystal compound can efficiently proceed.

Examples of the optional component to be contained in the liquid crystal composition may include additives including a polymerizable compound other than the polymerizable liquid crystal compound; a metal; a metal complex; a metal oxide such as titanium oxide; a colorant such as a dye and a pigment; a light-emitting material such as a fluorescent material and a phosphorescent material; a leveling agent; a thixotropic agent; a gelator; a polysaccharide; an ultraviolet ray absorber; an infrared absorber; an antioxidant; and an ion exchange resin. One type thereof may be solely used, and two or more types thereof may also be used in combination at any ratio.

The amount of the additives may be appropriately set within the range in which the effects of the present invention are not significantly impaired. Specifically, the amount of each of the additives may be 0.1 parts by weight to 20 parts by weight relative to 100 parts by weight of the polymerizable liquid crystal compound.

### [2.3. Description of Composition of Liquid Crystal Cured Layer]

The liquid crystal cured layer is the layer of the cured product obtained by curing the liquid crystal composition described above. In the cured product, the polymerizable liquid crystal compound is polymerized to be a polymer. The flowability of the polymerizable liquid crystal compound is usually lost by polymerization. Therefore, the liquid crystal cured layer that is the layer of the cured product obtained by curing the liquid crystal composition is a solid layer containing the polymer of the polymerizable liquid crystal compound.

The liquid crystal cured layer may contain the surfactant that has been contained in the liquid crystal compound. For example, when the surfactant has polymerizability, the liquid crystal cured layer may contain a polymer of the polymerizable liquid crystal compound and the surfactant, or a polymer of the surfactant.

In all these cases, the fluorine atoms contained in the molecule of the surfactant remain in the liquid crystal cured layer. Therefore, the fluorine atoms are detected by analysis of the surfaces (the front and back surfaces) of the liquid crystal cured layer by the X-ray photoelectron spectroscopy.

### [2.4. Description of Properties of Liquid Crystal Cured Layer]

It is preferable that the liquid crystal cured layer has a retardation suitable for the application of the optical film. For example, when it is desired to function the liquid crystal cured layer as a ¼ wave plate, the retardation Re of the liquid crystal cured layer is preferably 80 nm or more, more preferably 100 nm or more, and particularly preferably 120 nm or more, and is preferably 180 nm or less, more preferably 160 nm or less, and particularly preferably 150 nm or less. For example, when it is desired to function the liquid crystal cured layer as a ½ wave plate, the retardation Re of the liquid crystal cured layer is preferably 245 nm or more, more preferably 265 nm or more, and particularly preferably 270 nm or more, and is preferably 305 nm or less, more preferably 285 nm or less, and particularly preferably 280 nm or less.

It is preferable that the liquid crystal cured layer has a retardation with inverse wavelength dispersion. Herein, the retardation with inverse wavelength dispersion means retardation in which a retardation Re(450) at a wavelength of 450 nm, a retardation Re(550) at a wavelength of 550 nm, and a retardation Re(650) at a wavelength of 650 nm usually satisfy the following expression (D3), and preferably the following expression (D4). When the liquid crystal cured layer has a retardation with inverse wavelength dispersion, the liquid crystal cured layer can uniformly express a function over a wide bandwidth for optical applications such as a ¼ wave plate or a ½ wave plate.

Re(450)<Re(650) (D3)

Re(450)<Re(550)<Re(650) (D4)

Further, it is preferable that the liquid crystal cured layer has high transparency for use in optical applications. The total light transmittance of the liquid crystal cured layer is preferably 70% to 95%, more preferably 80% to 95%, and particularly preferably 90% to 95%. The total light transmittance may be measured at a wavelength range of 400 nm to 700 nm by using an ultraviolet-visible spectrophotometer.

### [2.5. Description of Size of Liquid Crystal Cured Layer]

The thickness of the liquid crystal cured layer may be appropriately set so that characteristics such as retardation can fall within a desired range. Specifically, the thickness of the liquid crystal cured layer is preferably 0.5 μm or more, and more preferably 1.0 μm or more, and is preferably 10 μm or less, more preferably 7 or less, further preferably 5 μm or less, and particularly preferably 3 μm or less.

The shape and length and width of the liquid crystal cured layer are not particularly limited. The shape of the liquid crystal cured layer may be a sheet piece shape or a long-length shape. The “long-length shape” herein means a shape having a length that is 5 times or more the width, and preferably 10 times or more the width, and specifically means a shape having a length that can be wound into a roll for storage or transportation.

[3. Substrate]

The substrate is a member used for forming the liquid crystal cured layer. Usually the liquid crystal composition is applied onto the surface of the substrate and the applied liquid crystal composition is cured to obtain the liquid crystal cured layer. In terms of obtaining a liquid crystal cured layer having a uniform thickness, it is preferable that the substrate is a member having a flat surface without concave and convex portions. The flat surface is the surface of the substrate on the liquid crystal cured layer side in the optical film.

As such a substrate, a resin film is usually used. As a resin contained in the resin film, a thermoplastic resin is usually used. In particular, from the viewpoint of high orientation-regulating force, high mechanical strength, and low cost, a resin having a positive intrinsic birefringence value is preferable. Further, it is preferable to use a resin containing an alicyclic structure-containing polymer as it has excellent transparency, low hygroscopicity, size stability, and light-weight properties.

The alicyclic structure-containing polymer is a polymer whose a structural unit contains an alicyclic structure, and is usually an amorphous polymer having no melting point. This alicyclic structure-containing polymer may have an alicyclic structure in a main chain, and may have an alicyclic structure in a side chain. In particular, it is preferable that the alicyclic structure-containing polymer has an alicyclic structure in a main chain from the viewpoint of mechanical strength and heat resistance.

Examples of the alicyclic structure may include a saturated alicyclic hydrocarbon (cycloalkane) structure and an unsaturated alicyclic hydrocarbon (cycloalkene and cycloalkyne) structure. Among these, a cycloalkane structure and a cycloalkene structure are preferable from the viewpoint of mechanical strength and heat resistance, and a cycloalkane structure is particularly preferable.

The number of carbon atoms constituting the alicyclic structure is preferably 4 or more, more preferably 5 or more, and particularly preferably 6 or more, and is preferably 30 or less, more preferably 20 or less, and particularly preferably 15 or less, per one alicyclic structure. When the number of carbon atoms constituting one alicyclic structure falls within this range, mechanical strength, heat resistance, and moldability of the substrate are highly balanced.

In the alicyclic structure-containing polymer, the ratio of a structural unit having the alicyclic structure may be appropriately selected according to the purposes of use. The ratio of the structural unit having the alicyclic structure in the alicyclic structure-containing polymer is preferably 50% by weight or more, more preferably 70% by weight or more, and particularly preferably 90% by weight or more. When the ratio of the structural unit having the alicyclic structure in the alicyclic structure-containing polymer falls within this range, transparency and heat resistance of the substrate are improved.

Examples of the alicyclic structure-containing polymer may include a norbornene-based polymer, a monocyclic olefin-based polymer, a cyclic conjugated diene-based polymer, a vinyl alicyclic hydrocarbon polymer, and hydrogenated products of these. Among these, a norbornene-based polymer is more preferable since it has favorable transparency and moldability.

Examples of the norbornene-based polymer may include a ring-opening polymer of a monomer having a norbornene structure, and a hydrogenated product thereof; and an addition polymer of a monomer having a norbornene structure, and a hydrogenated product thereof. Examples of the ring-opening polymer of a monomer having a norbornene structure may include a ring-opening homopolymer of one type of monomer having a norbornene structure, a ring-opening copolymer of two or more types of monomers having a norbornene structure, and a ring-opening copolymer of a monomer having a norbornene structure with an optional monomer copolymerizable therewith. Examples of the addition polymer of a monomer having a norbornene structure may include an addition homopolymer of one type of monomer having a norbornene structure, an addition copolymer of two or more types of monomers having a norbornene structure, and an addition copolymer of a monomer having a norbornene structure with an optional monomer copolymerizable therewith. Among these, the hydrogenated product of the ring-opening polymer of a monomer having a norbornene structure is particularly suitable from the viewpoint of moldability, heat resistance, low hygroscopicity, size stability, light-weight properties, and the like.

Examples of the monomer having a norbornene structure may include bicyclo[2.2.1]hept-2-ene (common name: norbornene), tricyclo[4.3.0.1^{2,5}]deca-3,7-diene (common name: dicyclopentadiene), 7,8-benzotricyclo[4.3.0.1^{2,5}]dec-3-ene (common name: methanotetrahydrofluorene), tetracyclo[4.4.0.1^{2,5}.1^{7,10}]dodec-3-ene (common name: tetracyclododecene), and derivatives of the compounds (for example, ones having a substituent in a ring). Examples of the substituent may include an alkyl group, an alkylene group, and a polar group. A plurality of substituents, which may be the same or different, may be bonded to the ring. As the monomer having a norbornene structure, one type thereof may be solely used, and two or more types thereof may also be used in combination at any ratio.

Examples of the type of the polar group may include a heteroatom and an atomic group having a heteroatom. Examples of the heteroatom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, a nitrile group, and a sulfonic acid group.

Examples of the monomer ring-opening copolymerizable with the monomer having a norbornene structure may include monocyclic olefins such as cyclohexene, cycloheptene, and cyclooctene, and derivatives thereof; and cyclic conjugated dienes such as cyclohexadiene and cycloheptadiene, and derivatives thereof. As the monomer that is ring-opening copolymerizable with the monomer having a norbornene structure, one type thereof may be solely used, and two or more types thereof may also be used in combination at any ratio.

The ring-opening polymer of the monomer having a norbornene structure may be produced, for example, by polymerization or copolymerization of the monomer in the presence of a ring-opening polymerization catalyst.

Examples of the monomer addition copolymerizable with the monomer having a norbornene structure may include α-olefins of 2 to 20 carbon atoms such as ethylene, propylene, and 1-butene, and derivatives thereof; cycloolefins such as cyclobutene, cyclopentene, and cyclohexene, and derivatives thereof; and non-conjugated dienes such as 1,4-hexadiene, 4-methyl-1,4-hexadiene, and 5-methyl-1,4-hexadiene. Among these, α-olefins are preferable, and ethylene is more preferable. As the monomer that is addition copolymerizable with the monomer having a norbornene structure, one type thereof may be solely used, and two or more types thereof may also be used in combination at any ratio.

The addition polymer of the monomer having a norbornene structure may be produced, for example, by polymerization or copolymerization of the monomer in the presence of an addition polymerization catalyst.

The hydrogenated products of the ring-opening polymer and the addition polymer described above may be produced, for example, by hydrogenation of a carbon-carbon unsaturated bond, preferably 90% or more of a carbon-carbon unsaturated bond, in a solution of the ring-opening polymer or the addition polymer in the presence of a hydrogenation catalyst containing a transition metal such as nickel or palladium.

The weight-average molecular weight (Mw) of the alicyclic structure-containing polymer is preferably 10,000 or more, more preferably 15,000 or more, and particularly preferably 25,000 or more, and is preferably 100,000 or less, more preferably 80,000 or less, and particularly preferably 50,000 or less. When the weight-average molecular weight falls within this range, the mechanical strength and molding processability of the substrate are highly balanced.

The molecular weight distribution (weight-average molecular weight (Mw)/number-average molecular weight (Mn)) of the alicyclic structure-containing polymer is preferably 1.0 or more, more preferably 1.2 or more, and particularly preferably 1.5 or more, and is preferably 10.0 or less, more preferably 4.0 or less, and particularly preferably 3.5 or less. When the molecular weight distribution is equal to or more than the lower limit value of the aforementioned range, productivity of the polymer can be enhanced, and production cost can be decreased.

When the molecular weight distribution is equal to or less than the upper limit value, the amount of low-molecular weight components is decreased. Therefore, relaxation during high-temperature exposure can be suppressed, and stability of the substrate can be enhanced.

The weight-average molecular weight (Mw) and the number-average molecular weight (Mn) may be measured as a weight-average molecular weight of polyisoprene equivalent by gel permeation chromatography using cyclohexane as a solvent. In the gel permeation chromatography, when a sample is not dissolved in cyclohexane, toluene may be used as the solvent. When toluene is used as the solvent, the weight-average molecular weight may be measured as polystyrene equivalent.

The glass transition temperature of the alicyclic structure-containing polymer is preferably 80° C. or higher and more preferably 100° C. or higher, and is preferably 250° C. or lower, more preferably 160° C. or lower, and particularly preferably 140° C. or lower. When the glass transition temperature of the alicyclic structure-containing polymer is equal to or more than the lower limit value of the aforementioned range, deformation and generation of stress in a high-temperature environment can be suppressed. Therefore, durability of the substrate can be enhanced. When the glass transition temperature of the alicyclic structure-containing polymer is equal to or less than the upper limit value of the aforementioned range, the stretching treatment of the substrate can be easily performed.

In the resin containing the alicyclic structure-containing polymer, the content of a resin component having a molecular weight of 2,000 or less is preferably 5% by weight or less, more preferably 3% by weight or less, and further preferably 2% by weight or less. Herein, the resin component having a molecular weight of 2,000 or less represents an oligomer component. When the amount of the oligomer component falls within the aforementioned range, generation of minute convex portions on the surface of the substrate is decreased, whereby unevenness of thickness is decreased and surface accuracy is improved. Examples of a method for decreasing the amount of the oligomer component may include a method of optimizing selection of the polymerization catalyst and the hydrogenation catalyst, the reaction conditions for polymerization and hydrogenation, and the temperature conditions in the step of molding the resin as a molding material into pellets. The amount of the oligomer component may be measured by the gel permeation chromatography described above.

The ratio of the alicyclic structure-containing polymer in the resin containing the alicyclic structure-containing polymer is preferably 70% by weight or more, more preferably 80% by weight or more, and particularly preferably 90% by weight or more. Accordingly, heat resistance of the substrate can be effectively enhanced.

The resin forming the substrate may further contain an optional component in combination with the aforementioned polymer. Examples of the optional component may include compounding agents including a colorant such as a dye and a pigment; a plasticizer; a fluorescent whitening agent; a dispersant; a thermal stabilizer; a photostabilizer; an antistatic agent; an ultraviolet absorber; an antioxidant; and a surfactant. One type thereof may be solely used, and two or more types thereof may also be used in combination at any ratio.

Specific suitable examples of the resin containing the alicyclic structure-containing polymer may include “ZEONOR 1420” and “ZEONOR 1420R” manufactured by ZEON Corporation.

In order to promote orientation of the polymerizable liquid crystal compound in the liquid crystal composition applied onto the surface of the substrate, the substrate may be subjected to a treatment for imparting an orientation-regulating force to the surface of the substrate. Herein, the “orientation-regulating force” means properties of a surface that can cause orientation of a polymerizable liquid crystal compound in a liquid crystal composition applied onto the surface.

Examples of the treatment for imparting the orientation-regulating force to the surface of the substrate may include a rubbing treatment. Examples of a method for rubbing treatment may include a method in which the surface of the substrate is rubbed in a constant direction by using a roll around which a cloth or felt formed of synthetic fibers such as nylon or natural fibers such as cotton is wound. It is preferable to wash the treated surface with a cleaning liquid such as isopropyl alcohol after the rubbing treatment, to remove minute powders generated during the rubbing treatment and clean the treated surface.

Further examples of the treatment for imparting the orientation-regulating force to the surface of the substrate may include a treatment of forming an orientation layer on the surface of the substrate. The orientation layer is a layer on which the polymerizable liquid crystal compound in the liquid crystal composition applied onto the orientation layer can be oriented in the plane in one direction. Therefore, when the orientation layer is provided, the liquid crystal composition may be applied onto the surface of the orientation layer.

The orientation layer usually contains a polymer such as a polyimide, a polyvinyl alcohol, a polyester, a polyarylate, a polyamideimide, or a polyetherimide. The orientation layer may be produced by applying a solution containing such a polymer onto the substrate in a film shape, drying the solution, and performing the rubbing treatment in one direction. In addition to the rubbing treatment, a method for irradiating the surface of the orientation layer with polarized ultraviolet light may also impart the orientation-regulating force to the orientation layer. The thickness of the orientation layer is preferably 0.001 μm to 5 μm, and more preferably 0.001 to 1 μm.

Further examples of the treatment for imparting the orientation-regulating force to the surface of the substrate may include a stretching treatment. When the stretching treatment is performed under the conditions suitable for the substrate, molecules of the polymer contained in the substrate can be oriented. Thereby the orientation-regulating force of causing orientation of the polymerizable liquid crystal compound in an orientation direction of molecules of the polymer contained in the substrate can be imparted to the surface of the substrate.

It is preferable that the stretching of the substrate is performed in a manner whereby anisotropy is imparted to the substrate and a slow axis is expressed in the substrate. Thereby the orientation-regulating force of causing orientation of the polymerizable liquid crystal compound in a direction parallel or perpendicular to the slow axis of the substrate is imparted to the surface of the substrate. For example, when a resin having a positive intrinsic birefringence value is used as a material for the substrate,

the molecules of the polymer contained in the substrate are usually oriented in a stretching direction to express a slow axis parallel to the stretching direction. Therefore, the orientation-regulating force of causing orientation of the polymerizable liquid crystal compound in the direction parallel to the slow axis of the substrate is imparted to the surface of the substrate. Accordingly, the stretching direction of the substrate may be set according to a desired orientation direction along which orientation of the polymerizable liquid crystal compound is intended. The stretching may be performed only in one direction or in two or more directions.

The stretching ratio may be set so that the birefringence Δn of the substrate after stretching falls within a desired range. The birefringence Δn of the substrate after stretching is preferably 0.000050 or more, and more preferably 0.000070 or more, and is preferably 0.007500 or less, and more preferably 0.007000 or less. When the birefringence Δn of the substrate after stretching is equal to or more than the lower limit value of the aforementioned range, a favorable orientation-regulating force can be imparted to the surface of the substrate. When the birefringence Δn is equal to or less than the upper limit value of the aforementioned range, retardation of the substrate can be decreased. Therefore, the liquid crystal cured layer and the substrate may be used in combination without peeling the substrate from the liquid crystal cured layer for various types of applications.

The stretching may be performed by a stretching machine such as a tenter stretching machine.

Further examples of the treatment for imparting the orientation-regulating force to the surface of the substrate may include an ion beam orientation treatment. In the ion beam orientation treatment, irradiation of the substrate with an ion beam of Ar⁺ or the like may be performed for imparting the orientation-regulating force to the surface of the substrate.

Among the treatments, the stretching treatment is particularly preferable. In the stretching treatment, molecular directors are oriented in an approximately uniform manner over the entire thickness direction of the substrate. Therefore by the stretching treatment, relaxation of orientation-regulating force over the lapse of time due to effects of environment (heat, light, oxygen, etc.) is less likely to occur as compared with other methods such as the rubbing treatment by which the orientation-regulating force is imparted to the surface of the substrate only by the molecular orientation in the vicinity of the surface of the substrate. The stretching treatment can suppress dust generation, cracking, and foreign matter contamination. Therefore, a liquid crystal cured layer having few orientation defects can thereby be easily obtained.

The substrate may have a retardation according to the applications. For example, when the optical film is used for applications such as a phase difference film and an optical compensation film, it is preferable that the substrate has a retardation. Specifically, the retardation Re of the substrate can be set according to the application of the optical film, and is preferably 30 nm or more, and more preferably 50 nm or more, and is preferably 500 nm or less, and more preferably 300 nm or less.

It is preferable that the substrate has excellent transparency. Specifically, the total light transmittance of the substrate is preferably 80% or more, more preferably 85% or more, and particularly preferably 88% or more. The haze of the substrate is preferably 5% or less, more preferably 3% or less, and particularly preferably 1% or less. The total light transmittance of the substrate may be measured at a wavelength range of 400 nm to 700 nm by using an ultraviolet-visible spectrophotometer. The haze of the substrate may be measured by cutting out a randomly selected portion of the substrate to obtain a thin-layer sample having a square shape of 50 mm×50 mm, and then performing measurement for the thin-layer sample using a haze meter.

As the substrate, a film having a sheet piece shape may be used. However, a long-length film is preferably used since it allows for roll-to-roll production and enhances the production efficiency.

When a long-length substrate is used, the slow axis of the substrate may be parallel to the lengthwise direction of the substrate, perpendicular to the lengthwise direction of the substrate, or in an oblique direction, which is not parallel or perpendicular to the lengthwise direction of the substrate. Specifically, the slow axis direction of the substrate may be set according to the direction of the slow axis that is intended to express in the liquid crystal cured layer. Examples of an angle formed between the slow axis of the substrate and the lengthwise direction of the substrate may include 15°±5°, 22.5°±5°, 45°±5°, 67.5±5°, and 75°±5°.

The thickness of the substrate is not particularly limited, but is preferably 1 μm or more, more preferably 5 μm or more, and particularly preferably 30 μm or more, and is preferably 1,000 μm or less, more preferably 300 μm or less, and particularly preferably 100 μm or less from the viewpoint of improving productivity and facilitating thickness reduction and weight reduction.

The method for producing the substrate is not limited. For example, the substrate formed of the thermoplastic resin such as the resin containing the alicyclic structure-containing polymer may be produced by a method including a step of molding the resin in a film shape to obtain the substrate.

Examples of the method for molding the resin may include a melt molding method and a solution casting method. Examples of the melt molding method may include a melt extrusion method in which molding is performed by melt extrusion, and a press molding method, an inflation molding method, an injection molding method, a blow molding method, and a stretch molding method. Among these methods, the melt extrusion method, the inflation molding method, and the press molding method are preferable from the viewpoint of obtaining a substrate having excellent mechanical strength and surface accuracy. Among these, the melt extrusion method is particularly preferable because the amount of remaining solvent can thereby be decreased and efficient and simple production can be performed.

Usually in the melt extrusion method, the resin is melt, and the melt resin is extruded from a dice, to mold the resin in a film shape. The melting temperature of the resin in an extruder provided with the dice is preferably Tg+80° C. or higher, and more preferably Tg+100° C. or higher, and is preferably Tg+180° C. or lower, and more preferably Tg+150° C. or lower. Herein, Tg means the glass transition temperature of the resin. When the melting temperature of the resin in the extruder is equal to or more than the lower limit value of this range, flowability of the resin can be sufficiently enhanced. When the melting temperature is equal to or less than the upper limit value, deterioration of the resin can be suppressed.

When the resin is molded in a film shape as described above, a substrate formed of the resin is obtained. The substrate thus obtained may be subjected to a step of imparting the orientation-regulating force to the surface of the substrate. In particular, a step of performing a stretching treatment is preferable.

As the stretching treatment, a uniaxial stretching treatment wherein stretching is effected only in one direction may be performed. Alternatively, a biaxial stretching treatment wherein stretching is effected in two different directions may also be performed. As the biaxial stretching treatment, a simultaneous biaxial stretching treatment wherein stretching is simultaneously effected in two directions may be performed. Alternatively, a sequential biaxial stretching treatment wherein stretching is effected in one direction and then effected in another direction may also be performed. As the stretching, any of a longitudinal stretching treatment in which stretching is performed in the lengthwise direction of the substrate, a transverse stretching treatment in which stretching is performed in a width direction of the substrate, and an oblique stretching treatment in which stretching is performed in an oblique direction, which is not parallel or perpendicular to the lengthwise direction of the substrate, may be performed. Alternatively, any of the combinations of these stretching treatments may be performed. The oblique stretching treatment is particularly preferable. Examples of the method for the stretching treatment may include a roll method, a float method, and a tenter method.

The stretching temperature and stretching ratio may be optionally set within a range in which a substrate having a surface with a desired orientation-regulating force is obtained. Specifically, the range of the stretching temperature is preferably Tg−30° C. or higher, and more preferably Tg−10° C. or higher, and is preferably Tg+10° C. or lower, and more preferably Tg or lower. The stretching ratio is preferably 1.1 times or more, more preferably 1.2 times or more, and particularly preferably 1.5 times or more, and is preferably 30 times or less, more preferably 10 times or less, and particularly preferably 5 times or less.

[4. Method for Producing Optical Film]

The optical film may be produced by a method including steps of applying the liquid crystal composition onto any surface to obtain the layer of the liquid crystal composition, and polymerizing the polymerizable liquid crystal compound in the applied liquid crystal composition to obtain the liquid crystal cured layer. Herein, as the surface onto which the liquid crystal composition is applied, the surface of the substrate is usually used.

Therefore, the optical film is usually produced by a method including steps of applying the liquid crystal composition onto the substrate to obtain the layer of the liquid crystal composition, and polymerizing the polymerizable liquid crystal compound contained in the liquid crystal composition applied to the substrate to obtain the liquid crystal cured layer.

In the step of applying the liquid crystal composition onto the substrate (application step), the liquid crystal composition is usually applied directly onto the surface of the substrate. Herein, applying the liquid crystal composition “directly” onto the surface of the substrate means applying in an aspect where no other layer is present between the layer of the liquid crystal composition formed by the application and the surface of the substrate. However, when the orientation layer is formed on the surface of the substrate, the liquid crystal composition may be applied onto the substrate through the orientation layer by applying the liquid crystal composition onto the orientation layer.

Examples of a method for applying the liquid crystal composition may include a curtain coating method, an extrusion coating method, a roll coating method, a spin coating method, a dip coating method, a bar coating method, a spray coating method, a slide coating method, a printing coating method, a gravure coating method, a die coating method, a gap coating method, and a dipping method. The thickness of the layer of the liquid crystal composition applied may be appropriately set according to a thickness required for the liquid crystal cured layer.

After the step of applying the liquid crystalline compound onto the substrate, a step of drying the applied liquid crystal composition (drying step) may be performed, if necessary. The drying step may be performed before the step of polymerizing the polymerizable liquid crystal compound contained in the applied liquid crystal composition. The drying removes the solvent from the layer of the liquid crystal composition applied onto the substrate. Such drying may be achieved by a drying method such as natural drying, heat drying, drying under reduced pressure, and heat drying under reduced pressure.

For example, when it is desired to cause orientation of the polymerizable liquid crystal compound in the liquid crystal composition to, for example, obtain a liquid crystal cured layer having a retardation, a step of causing orientation of the polymerizable liquid crystal compound contained in the layer of the applied liquid crystal composition (orientation step) may be performed after the step of applying the liquid crystal composition onto the substrate.

In the orientation step, the layer of the liquid crystal composition formed on the substrate is subjected to an orientation treatment such as heating, to thereby cause orientation of the polymerizable liquid crystal compound in a direction corresponding to the orientation-regulating force of the substrate. For example, when the substrate formed of the resin containing the alicyclic structure-containing polymer is used, homogeneous orientation along a direction approximately the same as the slow axis direction of the substrate may be achieved by the orientation treatment. Conditions for the orientation treatment may be appropriately set according to the properties of the liquid crystal composition used. Specific examples of the conditions of the orientation treatment may include conditions of treatment at a temperature of 50° C. to 160° C. for 30 seconds to 5 minutes.

However, the orientation of the polymerizable liquid crystal compound may be achieved immediately by applying the liquid crystal composition. In this case, orientation proceeds without the orientation treatment. Therefore, the layer of the liquid crystal composition may not necessarily be subjected to the orientation treatment for causing orientation of the polymerizable liquid crystal compound.

After the polymerizable liquid crystal compound is thus oriented as necessary, the step of polymerizing the polymerizable liquid crystal compound contained in the layer of the liquid crystal composition applied onto the substrate (polymerization step) is performed. As a result of the polymerization, usually the liquid crystal phase of the polymerizable liquid crystal compound is lost and curing of the liquid crystal composition is achieved. Accordingly, a desired liquid crystal cured layer is obtained.

As a method for polymerizing the polymerizable liquid crystal compound, a method suitable for the properties of components contained in the liquid crystal composition may be selected. Examples of the polymerization method may include an active energy ray irradiation method and a thermal polymerization method. Among these, the active energy ray irradiation method is preferable since heating is unnecessary and a polymerization reaction can proceed at room temperature. Here, the active energy ray for irradiation may include light such as visible light, ultraviolet light, and infrared light, as well as any energy ray such as an electron beam.

In particular, an irradiation method using light such as ultraviolet light is preferable since the operation thereof is simple. The temperature during irradiation with ultraviolet light is preferably equal to or less than the glass transition temperature of the substrate. The temperature is preferably 150° C. or lower, more preferably 100° C. or lower, and particularly preferably 80° C. or lower. The lower limit of the temperature during irradiation with ultraviolet light may be 15° C. or higher. The irradiation intensity of ultraviolet light is preferably 0.1 mW/cm² or more, and more preferably 0.5 mW/cm² or more, and is preferably 1,000 mW/cm² or less, and more preferably 600 mW/cm² or less.

By the aforementioned production method, an optical film having a multiple-layered structure including the substrate and the liquid crystal cured layer formed on the substrate is obtained. As to the liquid crystal cured layer, the surface fluorine atom amount measured by the X-ray photoelectron spectroscopy on the front surface opposite to the substrate and the surface fluorine atom amount measured by the X-ray photoelectron spectroscopy on the back surface on the substrate side satisfy the aforementioned requirements (a) and (b). Therefore, the produced optical film can suppress unevenness during irradiation with an HID lamp.

The liquid crystal curd layer contained in the produced optical film contains the polymer obtained by polymerization of the polymerizable liquid crystal compound. The polymer contained in the liquid crystal cured layer is obtained by polymerization of the polymerizable liquid crystal compound while the orientation of molecules in the liquid crystal phase is maintained. Therefore, the polymer contained in the liquid crystal cured layer may have homogeneous orientation regularity.

The orientation regularity of the polymer is usually along the direction according to the orientation-regulating force of the substrate. For example, when the substrate is formed of the resin containing the alicyclic structure-containing polymer, the substrate has the orientation-regulating force of causing orientation of the polymerizable liquid crystal compound in the direction parallel to the slow axis of the substrate. Therefore, in the optical film produced by using the substrate formed of the resin containing the alicyclic structure-containing polymer, the polymer obtained by polymerization of the polymerizable liquid crystal compound has homogeneous orientation regularity along the direction approximately the same as the direction of slow axis of the substrate.

Herein, “having homogeneous orientation regularity” means that long-axis directions of mesogens of molecules of the polymer are aligned in a certain direction parallel to a surface of the liquid crystal cured layer.

Further, the homogeneous orientation regularity “along” the certain direction means that the alignment direction is the certain direction. Moreover, the orientation along the direction that is “substantially” the same as the direction of the slow axis of the substrate means that the angle formed between the direction of the slow axis of the substrate and the alignment direction of the mesogens is usually 5° or less, preferably 3° or less, and more preferably 1° or less.

The long-axis directions of the mesogens of molecules of the polymer obtained by polymerization of the polymerizable liquid crystal compound is the long-axis direction of the mesogen of the polymerizable liquid crystal compound corresponding to the polymer. When the liquid crystal cured layer includes a plurality of types of mesogens having different orientation directions as in a case of using the compound (I) as the polymerizable liquid crystal compound, a direction in which a type of the mesogens having the longest length among the mesogens are aligned is the aforementioned alignment direction.

Such a liquid crystal cured layer usually has a slow axis parallel to the alignment direction of the aforementioned polymer according to the orientation regularity of the polymer obtained by polymerization of the polymerizable liquid crystal compound. The presence or absence of homogeneous orientation regularity of the polymer obtained by polymerization of the polymerizable liquid crystal compound and the alignment direction thereof may be confirmed by measurement of the slow axis direction by using a phase difference meter typified by AxoScan (Axometrics, Inc.) and measurement of retardation distribution of each incidence angle in the slow axis direction.

The method for producing the optical film may further include an optional step, in addition to the aforementioned steps. For example, the method for producing the optical film may include a step of peeling the formed liquid crystal cured layer from the substrate.

[5. Applications of Optical Film]

The optical film as it is may be used for any application. Alternatively the optical film may include an optional layer. Examples of the optional layer may include an adhesion layer for effecting adhesion to another member, a mat layer for improving the sliding properties of the film, a hardcoat layer such as an impact-resistant polymethacrylate resin layer, an antireflection layer, and an antifouling layer. The application is preferably an optical application, and particularly suitably a wave plate such as a ¼ wave plate and a ½ wave plate.

Examples of the application other than the wave plate may include a circularly polarizing plate. The circularly polarizing plate is provided with a linear polarizer and the optical film mentioned above.

As the linear polarizer, a known linear polarizer used in a device such as a liquid crystal display device may be used. Examples of the linear polarizer may include a linear polarizer obtained by causing a polyvinyl alcohol film to absorb iodine or a dichroic dye, and uniaxially stretching the film in a boric acid bath; and a linear polarizer obtained by causing a polyvinyl alcohol film to absorb iodine or dichroic dye, stretching the film, and modifying part of the polyvinyl alcohol unit in the molecular chain into a polyvinylene unit. Other examples of the linear polarizer may include a polarizer having a function of separating polarized light into reflective light and transmitted light, such as a grid polarizer, a multilayer polarizer, and a cholesteric liquid crystal polarizer. Among these, a polarizer containing polyvinyl alcohol is preferable.

When natural light is made incident on the linear polarizer, only one polarized light is transmitted. The polarization degree of the linear polarizer is preferably 98% or more, and more preferably 99% or more. The average thickness of the linear polarizer is preferably 5 μm to 80 μm.

It is preferable that the liquid crystal cured layer has such appropriate retardation that the optical film can function as a ¼ wave plate. The angle formed between the slow axis of the optical film and a transmission axis of the linear polarizer is preferably 45° or an angle close to 45° as viewed in the thickness direction, and preferably specifically 40° to 50°.

One of applications of such a circularly polarizing plate may be an application of antireflective film for a display device such as an organic electroluminescent display device. When the circularly polarizing plate is provided on a surface of the display device so that a surface on a linear polarizer side is disposed toward a viewer side, emission of light which has been made incident from the outside of the device and reflected inside the device to the outside of the device can be suppressed. As a result, glare on a display surface of the display device can be suppressed. Specifically, when light is incident from the outside of the device, only a part of linearly polarized light passes through the linear polarizer, which then passes through the optical film to be circularly polarized light. The circularly polarized light is reflected on a component in the device that reflects light (reflection electrode, etc.), and again passes through the optical film, resulting in linearly polarized light having a polarization axis in a direction perpendicular to the polarization axis of the linearly polarized light that has been incident. Thus, the light does not pass through the liner polarizer. Therefore, the antireflection function is achieved.

The circularly polarizing plate may be further provided with an optional layer, in addition to the linear polarizer and the optical film.

### EXAMPLES

Hereinafter, the present invention will be specifically described with reference to Examples. However, the present invention is not limited to Examples shown below. The present invention may be freely modified for implementation without departing from the scope of claims of the present invention and the scope of their equivalents.

Unless otherwise specified, “%” and “part(s)” that represent an amount in the following description are on the basis of weight. Unless otherwise specified, operations described below were performed under conditions of normal temperature and normal pressure.

[Evaluation Method]

### [1. Method for Measuring Surface Fluorine Atom Amount of Liquid Crystal Cured Layer]

From an optical film including a substrate and a liquid crystal cured layer, the substrate was peeled to obtain the liquid crystal cured layer. The liquid crystal cured layer was cut out to obtain a sample film of 1-cm square shape. A surface on a side where the surface fluorine atom amount was to be measured was turned upward, and the sample film was fixed to a sample holder. At that time, a conductive tape was used for the fixation of the sample film. The sample holder was installed in the following X-ray photoelectron spectroscopic system, and the surface fluorine atom amount of the front and back surfaces of the liquid crystal cured layer was measured under the following conditions. According to this method, the content by mole of fluorine (F) atoms contained in all atoms present on the surface of the liquid crystal cured layer except for hydrogen (H) can be measured.

System: “AXIS ULTRA” manufactured by Kratos Analytical Ltd.

Excitation X ray: Al Kα ray

Filament emission: 10 mA

Anode HT: 15 kV

Flood gun: Electron Neutralizer

Neutralization condition: Filament current: 1.55 A

Charge balance: 3.3 V

Filament bias: 1.5 V

Analysis area: about 700 μm×300 μm

Photoelectron detection angle: 0° (angle formed between sample surface and detector: 90°)

### [2. Method for Evaluating Surface State of Liquid Crystal Cured Layer by Using HID Lamp]

The optical film including the substrate and the liquid crystal cured layer was suspended in front of a black cloth in a dark room. The optical film was irradiated with light by using an HID lamp (“polarion light NP-1” manufactured by Polarion, power: 35 W) so that the surface of the optical film was obliquely irradiated with light. At that time, the optical film was visually observed, and then evaluated in accordance with the following criteria.

A: There were completely no unevenness in a dotted or blotted shape nor clouding, and transparency was excellent in appearance (after wiping the surface, no mark caused by wiping was found).

B: There was no unevenness in a dotted or blotted shape and there was no clouding (although it is not practically harmful, concern of slight mark remaining caused by wiping after wiping the surface is not completely eliminated).

C: There was no unevenness in a dotted or blotted shape, although clouding was slightly found on the surface.

D: Unevenness in dotted or blotted shape, and clouding were clearly found. Separately, the substrate without the liquid crystal cured layer was suspended in front of a black cloth in a dark room, and irradiated with light by using the aforementioned HID lamp so that the surface of the substrate was obliquely irradiated with light. Thus, the substrate alone was observed instead of the optical film. As a result, there was no unevenness in dotted or blotted shape, nor clouding. From the result, it was confirmed that occurrence of the unevenness and clouding observed in the evaluation described above was caused by the surface state of the liquid crystal cured layer.

### [3. Method for Evaluating Surface State of Liquid Crystal Cured Layer by Using Linear Polarizer]

The optical film including the substrate and the liquid crystal cured layer was cut out to prepare a sample film of 16-cm square size.

Two linear polarizers (polarizer and analyzer) were stacked on a light table in a state where the polarized light absorption axes of the linear polarizers were parallel to each other (parallel Nicols). The sample film was placed between the linear polarizers so that the angle of the slow axis of the sample film relative to the polarized light absorption axes of the linear polarizers was approximately 45° as viewed in the thickness direction. Subsequently, the sample film was visually observed with the light table turned on. The surface state was evaluated in accordance with the following criteria according to the uniformity of appearance (uniformity of retardation).

A: The appearance of the overall surface was almost uniform, and unevenness and defects were not recognized.

B: The appearance of the overall surface was almost uniform, but minute unevenness was slightly recognized.

C: Unevenness was clearly recognized.

D: Unevenness was strongly observed on the overall surface.

Separately, the substrate without the liquid crystal cured layer was placed between the pair of linear polarizers disposed on the light table, and visually observed. This substrate alone was used instead of the sample and observed. As a result, the appearance of the overall surface was almost uniform, and unevenness and defects were not recognized. From the results, it was confirmed that occurrence of the unevenness and defects observed in the evaluation described above was caused by the surface state of the liquid crystal cured layer.

### [4. Method for Evaluating Orientation Quality of Liquid Crystal Cured Layer]

As to the optical film including the substrate and the liquid crystal cured layer, the surface thereof on the side of the liquid crystal cured layer was bonded to a glass plate through a pressure-sensitive adhesive. The substrate was then peeled from the liquid crystal cured layer. As a result, a sample plate including the glass plate and the liquid crystal cured layer was obtained. The liquid crystal cured layer of the sample plate was observed with a polarized-light microscope using a X5 or X50 objective lens. During observation, the polarized-light microscope was set so that the polarized light absorption axes of polarizing plates provided in the polarized-light microscope were in perpendicular relationship (cross Nicol). During observation, the position of the sample plate was set to (i) an extinction position and (ii) a position where the slow axis of the liquid crystal cured layer was shifted from the extinction position by several degrees. The orientation quality was evaluated in the following criteria from the degree of orientation defects observed and a state of light leakage.

A: Orientation defects were not recognized, and there was almost no light leakage at the extinction position.

B: Orientation defects were slightly recognized, and there was slight light leakage at the extinction position.

C: Orientation defects were clearly recognized, and there was light leakage at the extinction position.

### [5. Method for Measuring Retardation of Liquid Crystal Cured Layer]

As to the optical film including the substrate and the liquid crystal cured layer, the surface thereof on the side of the liquid crystal cured layer was bonded to a glass plate through a pressure-sensitive adhesive. The substrate was then peeled from the liquid crystal cured layer. As a result, a sample plate including the glass plate and the liquid crystal cured layer was obtained. The in-plane retardation Re of the liquid crystal cured layer at wavelengths of 450 nm, 550 nm, and 650 nm was measured using this sample plate by a polarimeter (“AxoScan” manufactured by Axometrics, Inc.).

### [6. Method for Measuring Ratio of Fluorine Atom in Molecule of Surfactant]

A surfactant as a sample was weighed, and combusted in a combustion tube of an analyzer. A gas generated by the combustion was absorbed in a solution, to obtain an absorption liquid. Subsequently, part of the absorption liquid was analyzed by ion chromatography for measuring the ratio of fluorine atoms in the molecule of the surfactant. Conditions in each step are as follows.

(6.1. Conditions for Combustion and Absorption)

System: AQF-2100 and GA-210 (manufactured by Mitsubishi Chemical Corporation)

Electric furnace temperature: Inlet: 900° C., Outlet: 1,000° C.

Gas: Ar/O₂: 200 mL/min

O₂: 400 mL/min

Absorption liquid: solvent: H₂O₂ 90 μg/mL,
internal standard substance: P 4 μg/mL or Br 8 μg/mL

Amount of absorption liquid: 20 mL

(6.2. Conditions for Anion Analysis by Ion Chromatography)

System: ICS1600 (manufactured by DIONEX)

Mobile phase: 2.7 mmol/L Na₂CO₃/0.3 mmol/L NaHCO₃

Flow rate: 1.50 mL/min

Detector: electric conductivity detector

Injection volume: 20 μL

### Example 1

### (1-1. Production Of Pre-Stretch Substrate Formed Of Resin Containing Alicyclic Structure-Containing Polymer)

Pellets of a thermoplastic norbornene resin (“ZEONOR1420R” manufactured by ZEON Corporation) were dried at 90° C. for 5 hours. The dried pellets were supplied to an extruder, melted in the extruder, passed through a polymer pipe and a polymer filter, extruded from a T-die on a casting drum in a sheet shape, and cooled. Thus, a long-length pre-stretch substrate having a thickness of 60 μm and a width of 1,490 mm was produced. The produced pre-stretch substrate was wound to obtain a roll.

(1-2. Production Of Stretched Substrate Formed Of Resin Containing Alicyclic Structure-Containing Polymer)

The pre-stretch substrate described above was drawn from the roll, and supplied to a tenter stretching machine. Then stretching was performed by the tenter stretching machine so that the angle of the slow axis of a stretched substrate to be obtained after stretching relative to the winding direction of the stretched substrate was 45°. Both ends in the width direction of the film were trimmed, and the stretched substrate was wound to obtain a roll of the long-length stretched substrate having a width of 1,350 mm. The in-plane retardation Re of the resulting stretched substrate at a measurement wavelength of 550 nm was 148 nm, and the thickness thereof was 47 μm.

(1-3. Production of Liquid Crystal Composition)

100.0 parts of a polymerizable liquid crystal compound with inverse wavelength dispersion (E1) represented by the following Formula (E1), 0.30 parts of a surfactant

(“MEGAFACE F562” manufactured by DIC Corporation), 3.0 parts of a polymerization initiator (“IRGACURE379” manufactured by BASF), and 188.0 parts of cyclopentanone (manufactured by ZEON Corporation) and 282.0 parts of 1,3-dioxolane (manufactured by Toho Chemical Industry Co., Ltd.) as solvents were mixed to produce a liquid crystal composition in a liquid state.

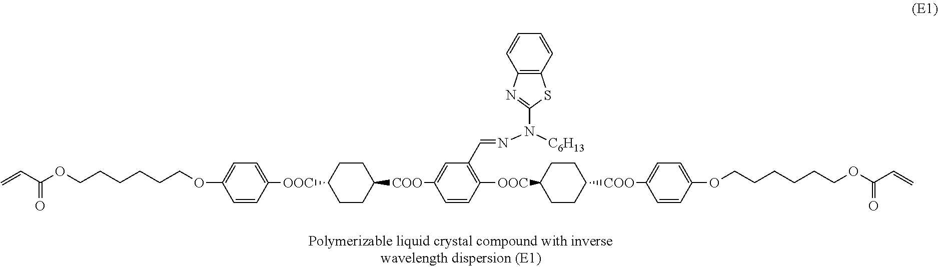

(1-4. Formation of Liquid Crystal Cured Layer)

The stretched substrate produced in the step (1-2) was drawn from the roll and conveyed in the lengthwise direction. The liquid crystal composition produced in the step (1-3) was applied onto one surface of the stretched substrate by a die coater to form a layer of the liquid crystal composition. The layer of the liquid crystal composition was subjected to an orientation treatment at 110° C. for 2 minutes, irradiated with ultraviolet light of 400 mJ/cm² under a N₂ atmosphere to cure the layer, to thereby form a liquid crystal cured layer. As a result, a long-length optical film having the stretched substrate and the liquid crystal cured layer having a dried thickness of 2.0 μm formed on the stretched substrate was obtained. The formed liquid crystal cured layer included a polymer obtained by polymerization of the polymerizable liquid crystal compound with inverse wavelength dispersion, and the polymer had homogeneous orientation regularity. The angle of the slow axis of the liquid crystal cured layer was confirmed to be 45° relative to the winding direction, that is the same as that of the slow axis of the stretched substrate used in application process.

The in-plane retardation of the liquid crystal cured layer of the produced optical film was measured by the aforementioned method. The in-plane retardation Re(450) at a measurement wavelength of 450 nm was 108 nm, the in-plane retardation Re(550) at a measurement wavelength of 550 nm was 138 nm, and the in-plane retardation Re(650) at a measurement wavelength of 650 nm was 143 nm. From the results, it was confirmed that the birefringence Δn of the polymerizable liquid crystal compound with inverse wavelength dispersion (E1) used in Example 1 has a property of increasing as the measurement wavelength increases (inverse wavelength dispersion).

The surface fluorine atom amount of each of the front and back surfaces of the liquid crystal cured layer in the optical film was measured by the aforementioned method. Further, in accordance with the aforementioned methods, evaluation of the surface state of the liquid crystal cured layer using an HID lamp, evaluation of the surface state of the liquid crystal cured layer using a linear polarizer, and evaluation of the orientation quality of the liquid crystal cured layer were performed.

### Examples 2 to 14 and Comparative Examples 1 to 11

Optical films were each produced and evaluated in the same manner as in Example 1 except that the type and amount of the surfactant were changed to those shown in Tables 1 and 2.

The liquid crystal cured layer provided to the produced optical films included a polymer obtained by polymerization of the polymerizable liquid crystal compound with inverse wavelength dispersion, and the included polymer had homogeneous orientation regularity. The angle of the slow axis of the liquid crystal cured layer relative to the winding direction was 45°.

[Results]

The results in Examples and Comparative Examples are shown in the following Tables 1 and 2. Abbreviations in Tables 1 and 2 mean as follows.

Surfactant “F562”: “MEGAFACE F-562” manufactured by DIC Corporation

Surfactant “S386”: “Surflon 5386” manufactured by AGC Seimi Chemical Co., Ltd.

Surfactant “650A”: “FTERGENT FTX-650A” manufactured by Neos Company Limited

Surfactant “601AD”: “FTERGENT FTX-601AD” manufactured by Neos Company Limited

Surfactant “F556”: “MEGAFACE F-556” manufactured by DIC Corporation

Surfactant “S243”: “Surflon 5243” manufactured by AGC Seimi Chemical Co., Ltd.

Surfactant “S651”: “Surflon 5651” manufactured by AGC Seimi Chemical Co., Ltd.

Surfactant “S420”: “Surflon 5420” manufactured by AGC Seimi Chemical Co., Ltd.

Surfactant “S611”: “Surflon 5611” manufactured by AGC Seimi Chemical Co., Ltd.

F amount: ratio of fluorine atoms in molecule of surfactant

Surfactant amount: amount of surfactant

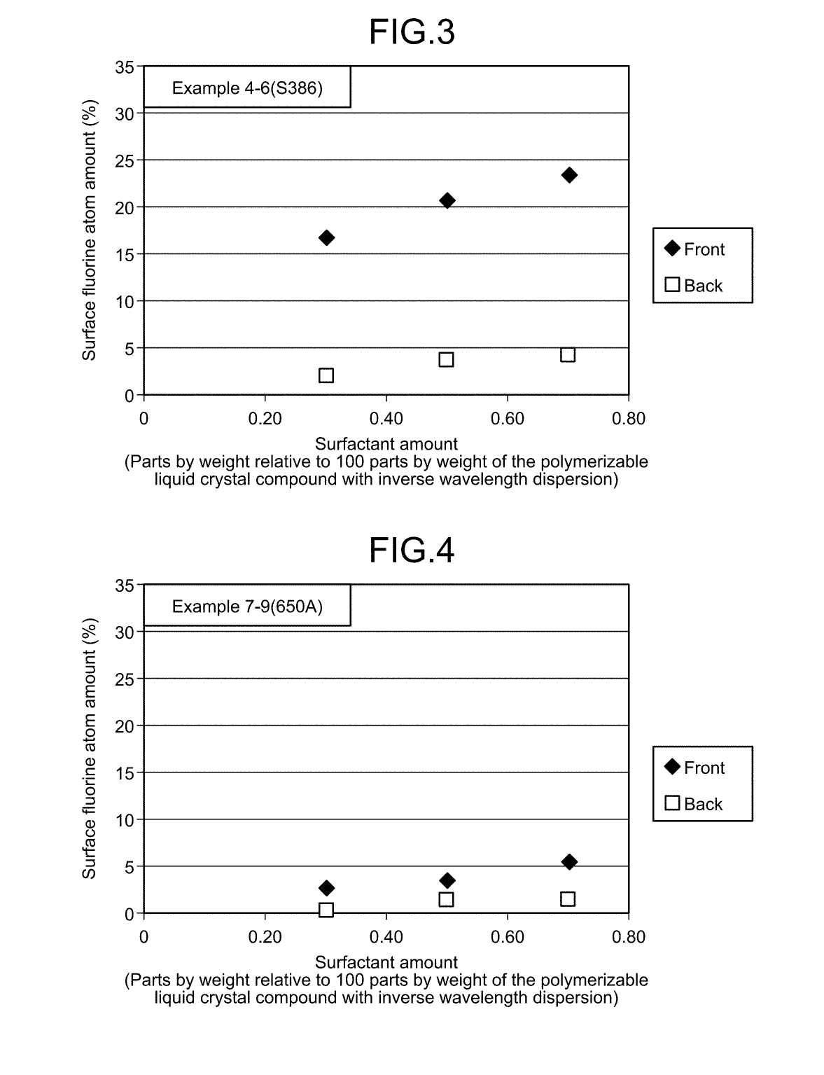

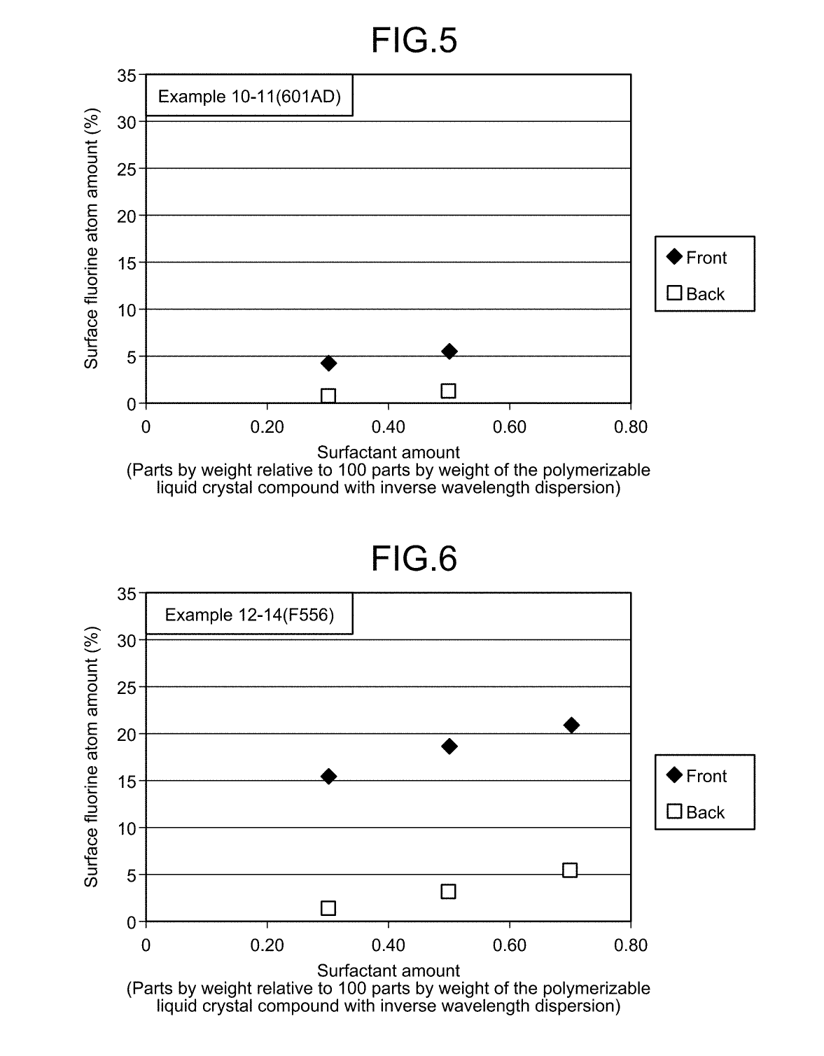

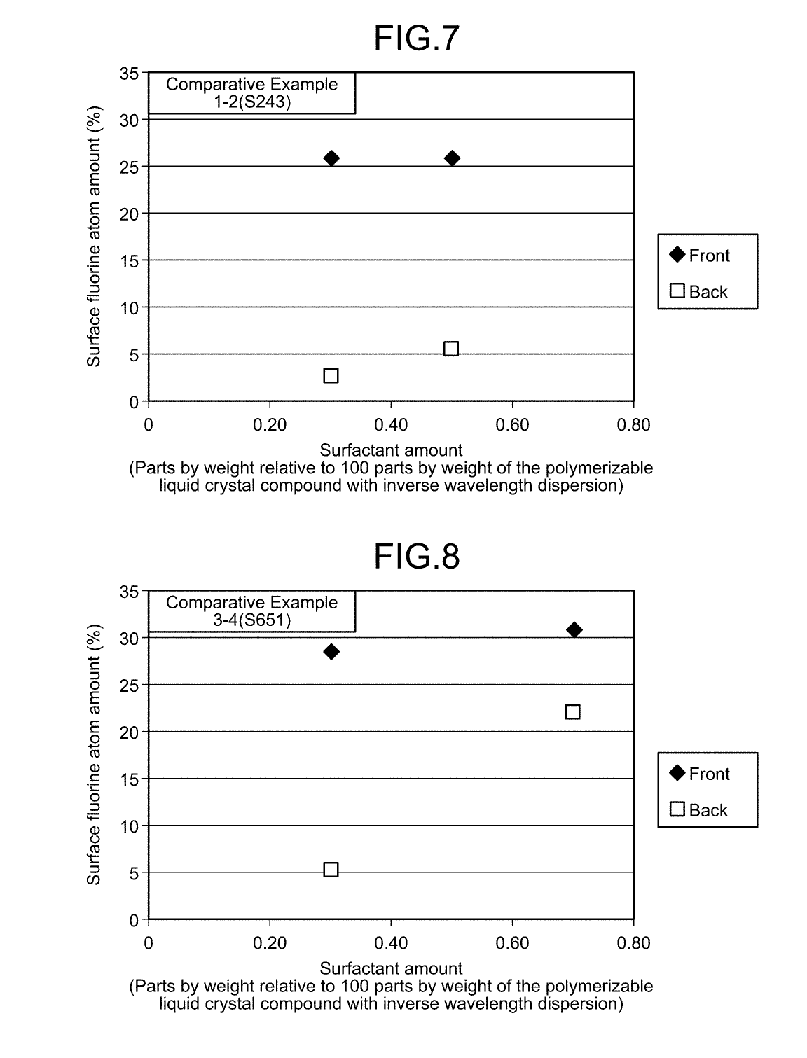

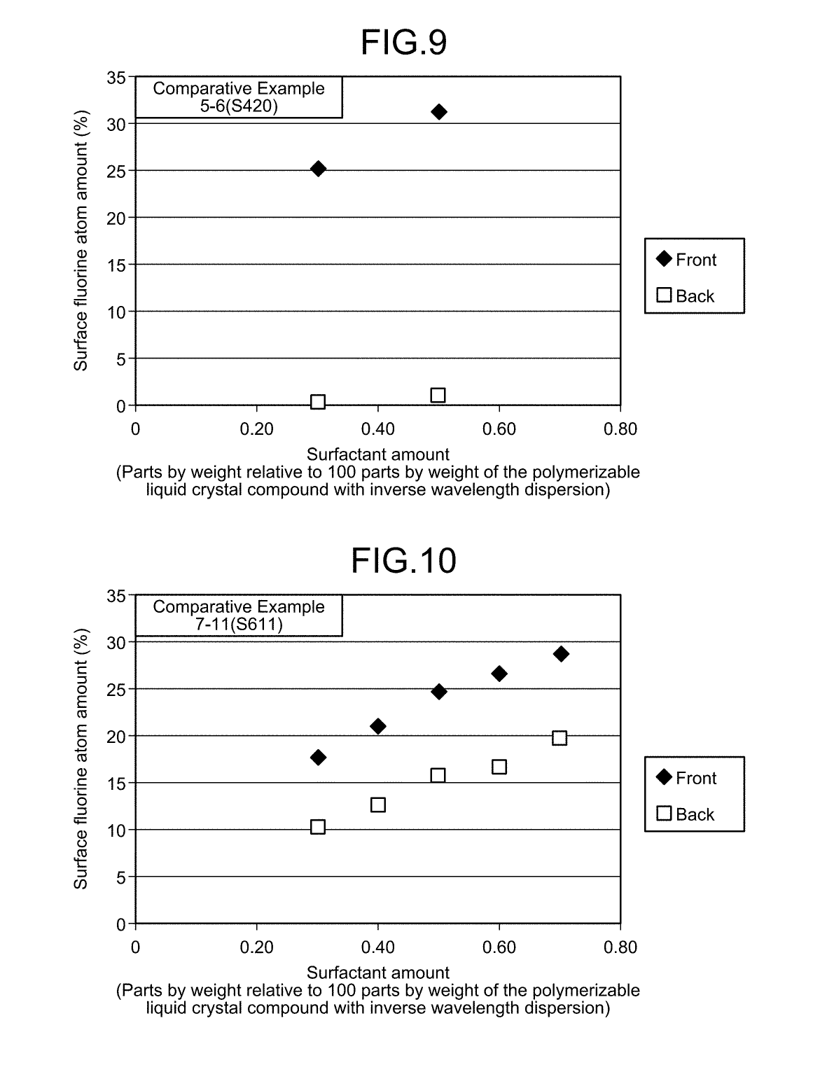

FIGS. 2 to 10 are graphs in which the surface fluorine atom amount of the liquid crystal cured layer measured in the optical film produced in each of Examples and Comparative Examples are plotted against the amount of the used surfactant. In FIGS. 2 to 10, a diamond plot represents the surface fluorine atom amount of the front surface of the liquid crystal cured layer, and a square plot represents the surface fluorine atom amount of the back surface of the liquid crystal cured layer.

TABLE 1
[Results of Examples]

| | Surfactant | | | | surface fluorine atom amount | | | | | |
|---|---|---|---|---|---|---|---|---|---|---|
| | | | F | Surfactant | Front | Back | ratio | Surface | Surface | |
| Ex. | | | amount | amount (parts | surface | surface | (back/ | state | state | Orientation |
| number | Abbreviation | Structure | (Wt %) | by weight) | (mol %) | (mol %) | front) | (HID lamp) | (polarizer) | quality |
| 1 | F562 | Oligomer | 11.4 | 0.30 | 16.7 | 1.9 | 0.11 | B | A | A |
| 2 | F562 | Oligomer | 11.4 | 0.50 | 19.7 | 2.7 | 0.14 | B | A | A |
| 3 | F562 | Oligomer | 11.4 | 0.70 | 20.6 | 3.2 | 0.16 | B | A | A |
| 4 | S386 | Dimer- | 10.8 | 0.30 | 16.7 | 1.8 | 0.11 | B | B | A |
| | | trimer | | | | | | | | |
| 5 | S386 | Dimer- | 10.8 | 0.50 | 20.8 | 3.8 | 0.18 | B | B | A |
| | | trimer | | | | | | | | |
| 6 | S386 | Dimer- | 10.8 | 0.70 | 23.6 | 4.3 | 0.18 | B | B | A |
| | | trimer | | | | | | | | |
| 7 | 650A | Oligomer/ | 1.2 | 0.30 | 2.7 | 0.3 | 0.11 | A | B | A |
| | | polymerizable | | | | | | | | |
| 8 | 650A | Oligomer/ | 1.2 | 0.50 | 3.6 | 1.4 | 0.39 | A | B | A |
| | | polymerizable | | | | | | | | |
| 9 | 650A | Oligomer/ | 1.2 | 0.70 | 5.6 | 1.4 | 0.25 | A | B | A |
| | | polymerizable | | | | | | | | |
| 10 | 601AD | Oligomer/ | 4.8 | 0.30 | 4.1 | 0.9 | 0.21 | A | B | A |
| | | polymerizable | | | | | | | | |
| 11 | 601AD | Oligomer/ | 4.8 | 0.50 | 5.5 | 1.3 | 0.24 | A | B | A |
| | | polymerizable | | | | | | | | |
| 12 | F556 | Oligomer | 11.0 | 0.30 | 15.5 | 1.3 | 0.08 | B | A | A |
| 13 | F556 | Oligomer | 11.0 | 0.50 | 18.6 | 3.1 | 0.17 | B | A | A |
| 14 | F556 | Oligomer | 11.0 | 0.70 | 20.9 | 5.3 | 0.25 | B | A | A |

TABLE 2
[Results of Comparative Examples]

| | Surfactant | | | | surface fluorine atom amount | | | | | |
|---|---|---|---|---|---|---|---|---|---|---|
| Comp. | | | F | Surfactant | Front | Back | ratio | Surface | Surface | |
| Ex. | | | amount | amount (parts | surface | surface | (back/ | state | state | Orientation |
| number | Abbreviation | Structure | (Wt %) | by weight) | (mol %) | (mol %) | front) | (HID lamp) | (polarizer) | quality |
| 1 | S243 | Monomer | 16.8 | 0.30 | 25.9 | 2.6 | 0.10 | D | A | A |
| 2 | S243 | Monomer | 16.8 | 0.50 | 25.8 | 5.6 | 0.22 | D | A | A |
| 3 | S651 | Dimer- | 26.3 | 0.30 | 28.5 | 5.2 | 0.18 | D | B | A |
| | | trimer | | | | | | | | |
| 4 | S651 | Dimer- | 26.3 | 0.70 | 30.9 | 22.1 | 0.72 | D | B | A |
| | | trimer | | | | | | | | |
| 5 | S420 | Monomer | 52.9 | 0.30 | 25.1 | 0.2 | 0.01 | C | D | A |
| 6 | S420 | Monomer | 52.9 | 0.50 | 31.2 | 1.1 | 0.04 | D | D | B |
| 7 | S611 | Dimer- | 11.8 | 0.30 | 17.7 | 10.3 | 0.58 | D | B | A |
| | | trimer | | | | | | | | |
| 8 | S611 | Dimer- | 11.8 | 0.40 | 21.0 | 12.8 | 0.61 | D | B | A |
| | | trimer | | | | | | | | |
| 9 | S611 | Dimer- | 11.8 | 0.50 | 24.6 | 15.8 | 0.64 | D | B | A |
| | | trimer | | | | | | | | |
| 10 | S611 | Dimer- | 11.8 | 0.60 | 26.7 | 16.7 | 0.63 | D | B | A |
| | | trimer | | | | | | | | |
| 11 | S611 | Dimer- | 11.8 | 0.70 | 28.8 | 19.7 | 0.68 | D | B | A |
| | | trimer | | | | | | | | |

[Evaluation]

As clear from Tables 1 and 2, even when the optical films according to the Examples were irradiated with an HID lamp with high intensity, unevenness and clouding were not recognized. This shows that a favorable surface state of the optical films is achieved.

In contrast, as to the optical films according to Comparative Examples, the surface state was not favorable under irradiation with the HID lamp. In particular, in Comparative Examples 7 to 9 in which the surface fluorine atom amount of the front surface of the liquid crystal cured layer was less than 25% by mole, and in Comparative Examples 1 to 3, 5, and 6 in which the surface fluorine amount ratio was 0.5% or less, a favorable surface state was not achieved under irradiation with the HID lamp with high intensity. Therefore, it was confirmed that only when a combination of (a) the surface fluorine atom amount of the front surface of the liquid crystal cured layer and (b) the surface fluorine amount ratio fallen within a specific range, an effect of improving the surface state under irradiation with the HID lamp with high intensity was obtained.

[Reference]

Unevenness that can be observed under irradiation with the HID lamp will be described below with reference to examples.

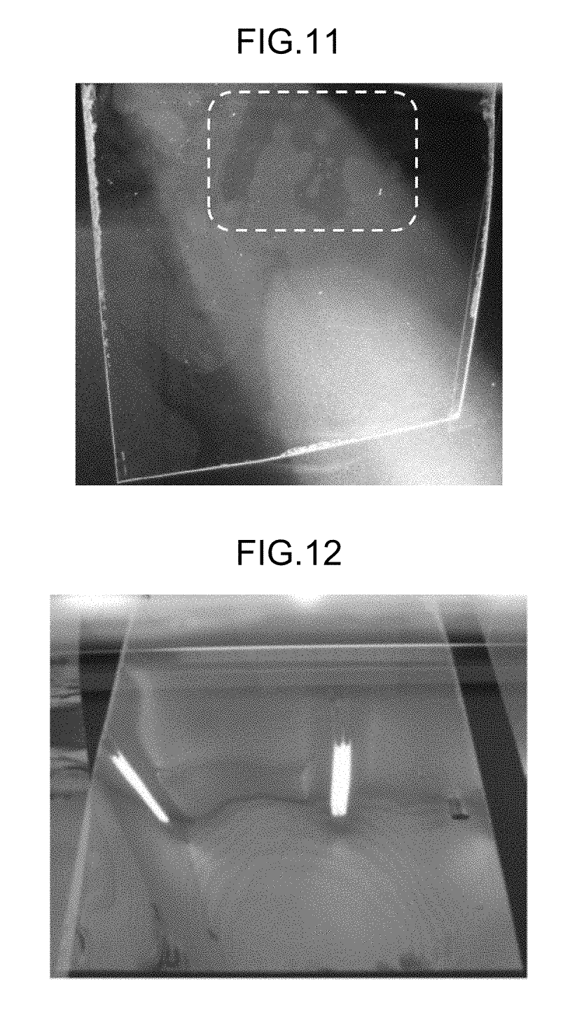

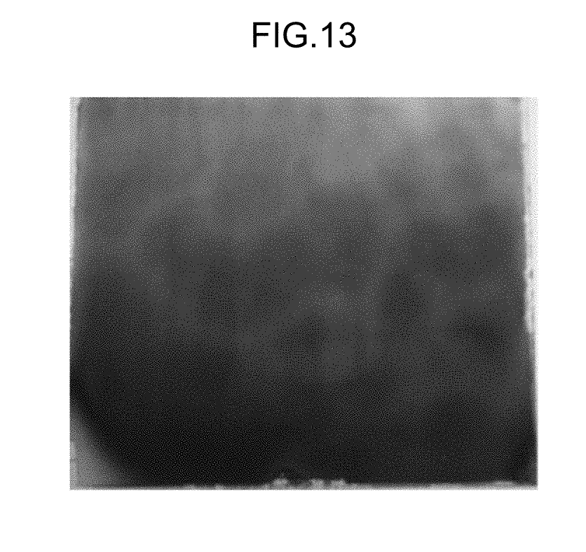

FIGS. 11 to 13 are photographs illustrating the same optical film. FIG. 11 illustrates a state of the optical film under irradiation with the HID lamp. FIG. 12 illustrates a state of the optical film under irradiation with a white fluorescent lamp. FIG. 13 illustrates a state where the optical film is placed between two linear polarizers layered so as to satisfy parallel Nicols as described in [3. Method for Evaluating Surface State of Liquid Crystal Cured Layer by Using Linear Polarizer].

As to the optical film under irradiation with the HID lamp with high intensity, unevenness may be observed as shown in a part surrounded by a dashed line in FIG. 11. In both the case wherein the optical film is under irradiation with a white fluorescent lamp as shown in FIG. 12 and the case wherein the optical film is placed between the two linear polarizers layered so as to satisfy parallel Nicols as shown in FIG. 13, the unevenness is not observed. Therefore, the unevenness is generated on the optical film only under irradiation with an HID lamp with high intensity. The unevenness is not generated in a general usage environment, and thus, the unevenness has not been recognized as a problem in prior art. The optical film of the present invention can solve the new problem that has not been recognized in prior art by those skilled in the art.

### REFERENCE SIGN LIST

100 optical film
110 layer of cured product
110U first surface
110D second surface
120 substrate

1. An optical film comprising a layer of a cured product obtained by curing a liquid crystal composition containing a polymerizable liquid crystal compound and a fluorine atom-containing surfactant, wherein
the layer has a first surface, and a second surface opposite to the first surface,
a surface fluorine atom amount measured by an X-ray photoelectron spectroscopy on the first surface is less than 25% by mole, and
a ratio by mole of the surface fluorine atom amount measured by the X-ray photoelectron spectroscopy on the second surface relative to the surface fluorine atom amount measured by the X-ray photoelectron spectroscopy on the first surface is 0.5 or less.

2. The optical film according to claim 1, wherein
the optical film includes a substrate,
the first surface is a surface of the layer opposite to the substrate, and
the second surface is a surface of the layer on the substrate side.

3. The optical film according to claim 1, wherein a ratio of fluorine atom in a molecule of the surfactant is 30% by weight or less.

4. The optical film according to claim 1, wherein the polymerizable liquid crystal compound is capable of expressing birefringence with inverse wavelength dispersion.

5. The optical film according to claim 1, wherein the polymerizable liquid crystal compound contains a main chain mesogen and a side chain mesogen bonded to the main chain mesogen in a molecule of the polymerizable liquid crystal compound.

6. The optical film according to claim 1, wherein the polymerizable liquid crystal compound is represented by the following Formula (I): 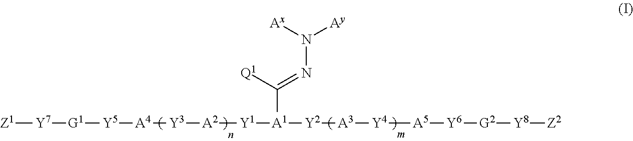
(in the Formula (I),
Y¹ to Y⁸ are each independently a chemical single bond, —O—, —S—, —O—C(═O)—, —C(═O)—O—, —O—C(═O)—O—, —NR¹—C(═O)—, —C(═O)—NR¹—, —O—C(═O)—NR¹—, —NR¹—C(═O)—O—, —NR¹—C(═O)—NR¹—, —O—NR¹—, or —NR¹—O—, wherein R¹ is a hydrogen atom or an alkyl group of 1 to 6 carbon atoms;
G¹ and G² are each independently a divalent aliphatic group of 1 to 20 carbon atoms optionally having a substituent; the aliphatic groups may have one or more per one aliphatic group of —O—, —S—, —O—C(═O)—, —C(═O)—O—, —O—C(═O)—O—, —NR²—C(═O)—, —C(═O)—NR²—, —NR²—, or —C(═O)— inserted therein; provided that a case where two or more —O— or —S— groups are adjacently inserted are excluded, wherein R² is a hydrogen atom or an alkyl group of 1 to 6 carbon atoms;
Z¹ and Z² are each independently an alkenyl group of 2 to 10 carbon atoms optionally being substituted by a halogen atom;
A^{x} is an organic group of 2 to 30 carbon atoms having at least one aromatic ring selected from the group consisting of an aromatic hydrocarbon ring and an aromatic heterocyclic ring;
A^{y} is a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, —C(═O)—R³, —SO₂—R⁴, —C(═S)NH—R⁹, or an organic group of 2 to 30 carbon atoms having at least one aromatic ring selected from the group consisting of an aromatic hydrocarbon ring and an aromatic heterocyclic ring, wherein R³ is an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic hydrocarbon ring group of 5 to 12 carbon atoms; R⁴ is an alkyl group of 1 to 20 carbon atoms, an alkenyl group of 2 to 20 carbon atoms, a phenyl group, or a 4-methylphenyl group; R⁹ is an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic group of 5 to 20 carbon atoms optionally having a substituent; the aromatic ring that A^{x} and A^{y} have may have a substituent; and A^{x} and A^{y} may form a ring together;
A¹ is a trivalent aromatic group optionally having a substituent;
A² and A³ are each independently a divalent alicyclic hydrocarbon group of 3 to 30 carbon atoms optionally having a substituent;
A⁴ and A⁵ are each independently a divalent aromatic group of 6 to 30 carbon atoms optionally having a substituent;
Q¹ is a hydrogen atom or an alkyl group of 1 to 6 carbon atoms optionally having a substituent; and
m and n are each independently 0 or 1).

7. A method for producing an optical film comprising steps of:
applying a liquid crystal composition containing a polymerizable liquid crystal compound and a fluorine atom-containing surfactant onto a substrate; and
polymerizing the polymerizable liquid crystal compound contained in the liquid crystal composition applied onto the substrate, to obtain a layer of a cured product of the liquid crystal composition, wherein
a surface fluorine atom amount measured by an X-ray photoelectron spectroscopy on the surface opposite to the substrate of the layer is less than 25% by mole, and
a ratio by mole of the surface fluorine atom amount measured by the X-ray photoelectron spectroscopy on a surface on the substrate side of the layer relative to the surface fluorine atom amount measured by the X-ray photoelectron spectroscopy on the surface opposite to the substrate of the layer is 0.5 or less.
